(19) United States
(12) Patent Application Publication
(10) Pub. No.: US 2025/0319336 A1
(43) Pub. Date: Oct. 16, 2025

(54) AERIAL-BASED FIREFIGHTING USING A SUSPENDED AUTONOMOUS FIRE EXTINGUISHER

(71) Applicants: University of Florida Research Foundation, Incorporated, Gainesville, FL (US); Fire Neural Network, Gainesville, FL (US)

(72) Inventors: Peter G. Ifju, Gainesville, FL (US); Imre Bartos, Gainesville, FL (US); Istvan Kereszy, Gainesville, FL (US)

(21) Appl. No.: 19/171,612

(22) Filed: Apr. 7, 2025

Related U.S. Application Data
(60) Provisional application No. 63/632,106, filed on Apr. 10, 2024.

(51) Int. Cl. A62C 3/02; B64D 1/18; G05D 1/495; G05D 1/644; G05D 105/55

(52) U.S. Cl. CPC A62C 3/0242; B64D 1/18; G05D 1/495; G05D 1/6445; G05D 2105/55

(57) ABSTRACT

Various embodiments of the present disclosure provide systems and methods for aerial-based firefighting using a suspended autonomous fire extinguisher.

### CROSS-REFERENCE TO RELATED APPLICATIONS

This application claims priority to U.S. Application No. 63/632,106 filed Apr. 10, 2024, which is hereby incorporated by reference in its entirety.

### TECHNICAL FIELD

The present application relates to the technical field of firefighting. In particular, the invention relates to systems and methods for aerial-based firefighting using a suspended autonomous fire extinguisher (SAFE).

### BACKGROUND

Lightning strikes lead to seventy percent of all areas burned in the United States. Some fires ignite due to combustible forest litter and other fires ignite along the length of tree trunks or even in the canopy. If the ignition is extinguished early enough, fire spread is avoided. As wildfires typically double in size every few minutes during their early spread, early detection and suppression is highly important. For remote areas, existing technologies for extinguishing fires include the use of conventional firefighting aircraft, such as tanker aircraft or helicopters, which can travel to an ignition site more quickly than land-based vehicles. This is especially true in environments with no nearby roads and where the landscape is difficult to traverse. While conventional aerial vehicles can suppress fires after several drops of fire suppressants, they are suboptimal for rapid fire suppression as they are unable to get sufficiently close to extinguish the fires for two reasons. First, conventional aerial vehicles may create substantial downdrafts that fuel the fire. Second, for fires in forests, the aerial vehicle may not have space to sufficiently approach the fire for targeted application of a fire suppressant.

Lightning strikes lead to seventy percent of all areas burned in the United States. Some fires ignite due to combustible forest litter and other fires ignite along the length of tree trunks or even in the canopy. If the ignition is extinguished early enough, fire spread is avoided. As wildfires typically double in size every few minutes during their early spread, early detection and suppression is important.

For remote areas, existing technologies for extinguishing fires include the use of conventional firefighting aircraft, such as tanker planes or helicopters. These aerial vehicles can often reach ignition sites more quickly than ground-based vehicles, especially in environments with limited road access or challenging terrain. However, conventional aerial firefighting approaches face certain limitations.

One challenge is that the downdraft created by aircraft rotors or propellers may inadvertently fan the flames, potentially exacerbating the fire. Additionally, in densely forested areas, aerial vehicles may have difficulty maneuvering close enough to precisely apply fire suppressants to the ignition source. The canopy and other obstacles can impede direct access to fires on the ground or along tree trunks.

Current aerial firefighting methods typically involve dropping large volumes of water or fire retardant from a height above the tree canopy. While this approach can be effective for larger fires, it may lack the precision needed for targeted suppression of small, nascent ignitions. Improving the accuracy and efficiency of aerial fire suppression techniques could enhance wildfire prevention efforts.

Thus, there is a need for firefighting systems that can combine the rapid response capabilities of aerial vehicles with more precise and targeted application of fire suppressants. Advancements in this area could potentially improve outcomes in wildfire management and forest protection.

### BRIEF SUMMARY

The present disclosure provides a high-precision, autonomously guided, tethered, fire extinguishing device (e.g., a suspended autonomous fire extinguisher (SAFE)) connected to an aerial vehicle, such as a station holding crewed or uncrewed aerial asset. The fire extinguishing device may be used in dense forests to extinguish fires on the ground as well as at any position along a tree trunk. The fire extinguishing device may apply fire suppressant to a fire while the aerial vehicle that holds the tether is sufficiently far to generate only insignificant airflow at the ignition site. The firefighting system of the present disclosure may be utilized in a variety of environments, such as grasslands, urban areas, and forests. Additionally, the system is durable and capable of contacting and displacing tree branches and limbs.

In one embodiment, a system includes an aerial vehicle comprising a first propulsion system, the aerial vehicle configured to travel to a location associated with a fire, wherein the location is a threshold distance from a fire location (e.g., far above the fire); a tether assembly configured to extend a retractable tether based at least in part on the aerial vehicle travelling to the location; and a fire extinguishing device coupled to the tether assembly and comprising a second propulsion system (e.g., that produces thrust in the horizontal plane), the fire extinguishing device configured to (i) expel a fire suppressant towards the fire and (ii) perform one or more stabilization operations using the second propulsion system based at least in part on expelling the fire suppressant.

In some examples, the system includes one or more processors configured to determine one or more propulsion parameters for the second propulsion system based at least in part on one or more fire suppressant parameters, wherein the one or more stabilization operations are based at least in part on the one or more propulsion parameters. In some examples, the system includes one or more processors configured to determine the threshold distance based at least in part on one or more downdraft values. In some examples, the fire extinguishing device comprises one or more sensors configured to detect the fire location.

In some examples, the tether assembly is configured to lower the fire extinguishing device to a fire extinguishing device approach location, the fire extinguishing device approach location based at least in part on the fire location. In some examples, the system includes one or more processors configured to determine the fire extinguishing device approach location based at least in part on sensor data from one or more sensors of the fire extinguishing device. In some examples, the system includes one or more second vehicles configured to determine the fire location and communicate the fire location to the aerial vehicle. In some examples, the aerial vehicle is configured to determine the fire location.

In some examples, the system includes one or more processors configured to determine the fire location based at least in part on lightning strike data and moisture-based fire risk data. In some examples, the fire extinguishing device comprises one or more wedge structures configured to displace one or more obstacles.

In one embodiment, a method includes causing, by one or more processors, an aerial vehicle comprising a first propulsion system to travel to a location associated with a fire, wherein the location is a threshold distance from a fire location; causing, by the one or more processors, a tether assembly to extend a retractable tether based at least in part on the aerial vehicle travelling to the location; and causing, by the one or more processors, a fire extinguishing device coupled to the tether assembly and comprising a second propulsion system to (i) expel a fire suppressant towards the fire and (ii) perform one or more stabilization operations using the second propulsion system based at least in part on expelling the fire suppressant.

In some examples, the method includes determining, by the one or more processors, one or more propulsion parameters for the second propulsion system based at least in part on one or more fire suppressant parameters, wherein the one or more stabilization operations use the one or more propulsion parameters. In some examples, the method includes determining, by the one or more processors, the threshold distance based at least in part on one or more downdraft values. In some examples, the fire extinguishing device comprises one or more sensors configured to detect the fire location.

In some examples, causing the tether assembly to extend the retractable tether includes causing, by the one or more processors, the tether assembly to lower the fire extinguishing device to a fire extinguishing device approach location, the fire extinguishing device approach location based at least in part on the fire location. In some examples, the method includes determining, by the one or more processors, the fire extinguishing device approach location based at least in part on sensor data from one or more sensors of the fire extinguishing device.

In some examples, the method includes receiving, by the one or more processors and from one or more second vehicles, an indication of the fire location. In some examples, the method includes determining, by the one or more processors, the fire location, wherein the aerial vehicle comprises the one or more processors. In some examples, the method includes determining, by the one or more processors, the fire location based at least in part on lightning strike data and moisture-based fire risk data.

In one embodiment, an apparatus includes at least one processor; and at least one memory storing instructions that, when executed by the at least one processor, cause the apparatus to: travel, using a first propulsion system, to a location associated with a fire, wherein the location is a threshold distance from a fire location; extend, using a tether assembly, a retractable tether based at least in part on travelling to the location; and expel, via a fire extinguishing device, a fire suppressant towards the fire and perform one or more stabilization operations based at least in part on expelling the fire suppressant.

### BRIEF DESCRIPTION OF THE DRAWINGS

Reference will now be made to the accompanying drawings, which are not necessarily drawn to scale, and wherein:

FIG. 1 illustrates an example computing system in accordance with one or more embodiments of the present disclosure.

FIG. 2 is a schematic diagram showing a system computing architecture in accordance with some embodiments discussed herein.

FIG. 3 illustrates a data flow diagram in accordance with some embodiments discussed herein.

FIG. 4 illustrates a data flow diagram in accordance with some embodiments discussed herein.

FIG. 5 illustrates an operational example of a firefighting system in accordance with some embodiments discussed herein.

FIG. 6 illustrates an operational example of a fire extinguishing device in accordance with some embodiments discussed herein.

FIG. 7 illustrates an operational example of a fire extinguishing device in accordance with some embodiments discussed herein.

FIG. 8 illustrates an operational example of a fire extinguishing device in accordance with some embodiments discussed herein.

FIG. 9 illustrates an operational example of positioning configurations for a fire extinguishing device in accordance with some embodiments discussed herein.

FIG. 10 illustrates an operational example of a firefighting system in accordance with some embodiments discussed herein.

FIG. 11 illustrates an example flowchart in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like). A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for, or used in addition to, the computer-readable storage media described above.

As should be appreciated, various embodiments of the present disclosure may also be implemented as methods, apparatuses, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example System Framework

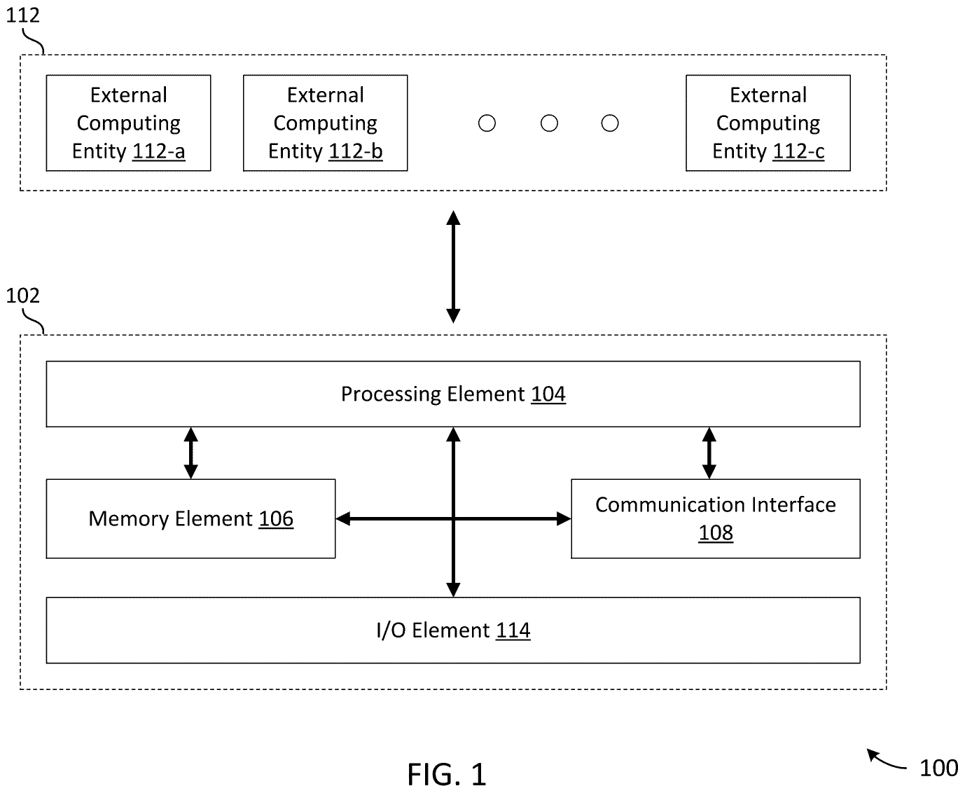

FIG. 1 illustrates an example computing system 100 in accordance with one or more embodiments of the present disclosure. The computing system 100 may include a computing entity 102 and/or one or more external computing entities 112 (e.g., external computing entity 112-a, external computing entity 112-b, external computing entity 112-c) communicatively coupled to the computing entity 102 using one or more wired and/or wireless communication techniques. The computing entity 102 may be specially configured to perform one or more steps/operations of one or more techniques described herein. In some embodiments, the computing entity 102 may include and/or be in association with one or more mobile device(s), desktop computer(s), laptop(s), server(s), cloud computing platform(s), and/or the like. In some example embodiments, the computing entity 102 may be configured to receive and/or transmit information, such as one or more datasets, data objects, and/or the like from and/or to the external computing entities 112 to perform one or more steps/operations as described herein (e.g., steps/operations for aerial-based firefighting).

The computing entity 102, for example, may include and/or be associated with one or more entities that may be configured to receive, transmit, store, and/or manage information, such as information indicative of one or more locations associated with a fire and/or environmental information. For example, an aerial vehicle and/or a fire extinguishing device as described herein may include one or more computing entities 102, which may be configured to receive, determine, generate, and/or transmit information, such as information associated with one or more fires. In some examples, the computing entity 102 may display information via a user interface of the computing entity 102. Additionally, or alternatively, the computing entity 102 may display information via a user interface of an external computing entity 112. In some examples, the computing entity 102 may communicate information to vehicles, which may include one or more external computing entities 112.

The external computing entities 112, for example, may include and/or be associated with one or more entities that may be configured to receive, transmit, store, and/or manage information, such as information indicative of one or more locations associated with a fire and/or environmental information. The external computing entities 112, for example, may be associated with one or more data repositories, cloud platforms, compute nodes, organizations, and/or the like, which may be individually and/or collectively leveraged to obtain and aggregate data for an individual.

The computing entity 102 may include, or be in communication with, one or more processing elements 104 (also referred to as processors, processing circuitry, digital circuitry, and/or similar terms used herein interchangeably) that communicate with other elements within the computing entity 102 via a bus, for example. As will be understood, the computing entity 102 may be embodied in a number of different ways. The computing entity 102 may be configured for a particular use or configured to execute instructions stored in volatile or non-volatile media or otherwise accessible to the processing element 104. As such, whether configured by hardware or computer program products, or by a combination thereof, the processing element 104 may be capable of performing steps or operations according to embodiments of the present disclosure when configured accordingly.

In one embodiment, the computing entity 102 may further include, or be in communication with, one or more memory elements 106. The memory element 106 may be used to store at least portions of the databases, database instances, database management systems, data, applications, programs, program modules, scripts, source code, object code, byte code, compiled code, interpreted code, machine code, executable instructions, and/or the like being executed by, for example, the processing element 104. Thus, the databases, database instances, database management systems, data, information, applications, programs, program modules, scripts, source code, object code, byte code, compiled code, interpreted code, machine code, executable instructions, and/or the like, may be used to control certain aspects of the operation of the computing entity 102 with the assistance of the processing element 104.

As indicated, in one embodiment, the computing entity 102 may also include one or more communication interfaces 108 for communicating with various computing entities, e.g., external computing entities 112, such as by communicating data, content, information, and/or similar terms used herein interchangeably that may be transmitted, received, operated on, processed, displayed, stored, and/or the like.

The computing system 100 may include one or more input/output (I/O) element(s) 114 for communicating with one or more users. An I/O element 114, for example, may include one or more user interfaces for providing and/or receiving information from one or more users of the computing system 100. The I/O element 114 may include one or more tactile interfaces (e.g., keypads, touch screens, and/or the like), one or more audio interfaces (e.g., microphones, speakers, and/or the like), visual interfaces (e.g., display devices, and/or the like), and/or the like. The I/O element 114 may be configured to receive user input through one or more of the user interfaces from a user of the computing system 100 and provide data to a user through the user interfaces.

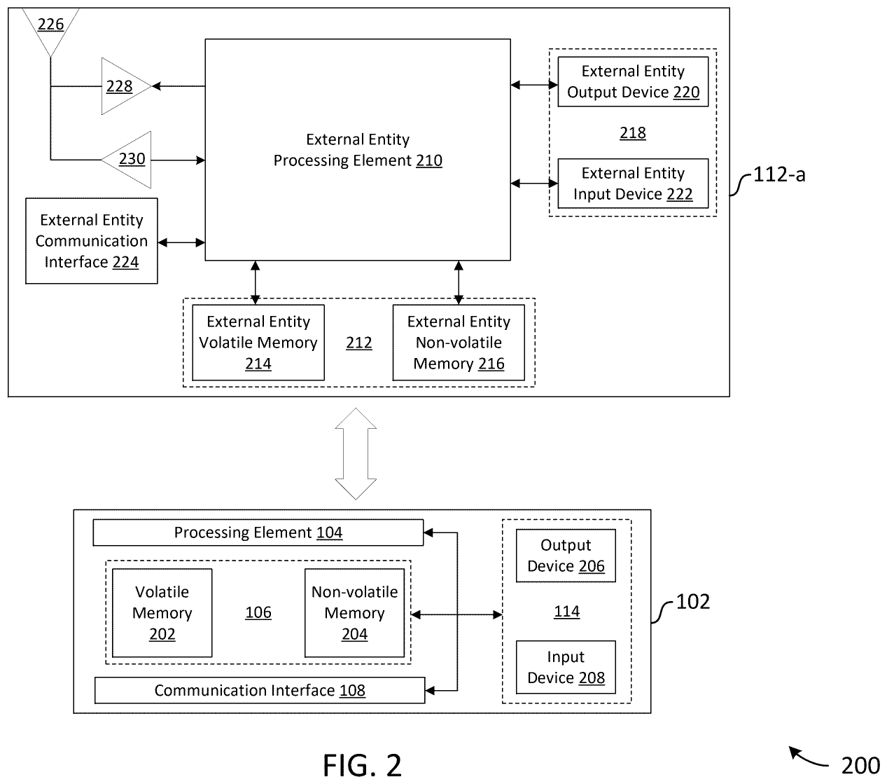

FIG. 2 is a schematic diagram showing a system computing architecture 200 in accordance with some embodiments discussed herein. In some embodiments, the system computing architecture 200 may include the computing entity 102 and/or the external computing entity 112-a of the computing system 100. The computing entity 102 and/or the external computing entity 112-a may include a computing apparatus, a computing device, and/or any form of computing entity configured to execute instructions stored on a computer-readable storage medium to perform certain steps or operations.

The computing entity 102 may include a processing element 104, a memory element 106, a communication interface 108, and/or one or more I/O elements 114 that communicate within the computing entity 102 via internal communication circuitry, such as a communication bus and/or the like.

The processing element 104 may be embodied as one or more complex programmable logic devices (CPLDs), microprocessors, multi-core processors, coprocessing entities, application-specific instruction-set processors (ASIPs), microcontrollers, and/or controllers. Further, the processing element 104 may be embodied as one or more other processing devices or circuitry including, for example, a processor, one or more processors, various processing devices, and/or the like. The term circuitry may refer to an entirely hardware embodiment or a combination of hardware and computer program products. Thus, the processing element 104 may be embodied as integrated circuits, application specific integrated circuits (ASICs), field programmable gate arrays (FPGAs), programmable logic arrays (PLAs), hardware accelerators, digital circuitry, and/or the like.

The memory element 106 may include volatile memory 202 and/or non-volatile memory 204. The memory element 106, for example, may include volatile memory 202 (also referred to as volatile storage media, memory storage, memory circuitry, and/or similar terms used herein interchangeably). In one embodiment, a volatile memory 202 may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for, or used in addition to, the computer-readable storage media described above.

The memory element 106 may include non-volatile memory 204 (also referred to as non-volatile storage, memory, memory storage, memory circuitry, and/or similar terms used herein interchangeably). In one embodiment, the non-volatile memory 204 may include one or more non-volatile storage or memory media, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In one embodiment, a non-volatile memory 204 may include a floppy disk, flexible disk, hard disk, solid-state storage (SSS) (e.g., a solid-state drive (SSD)), solid state card (SSC), solid state module (SSM), enterprise flash drive, magnetic tape, or any other non-transitory magnetic medium, and/or the like. A non-volatile memory 204 may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile memory 204 may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

As will be recognized, the non-volatile memory 204 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

The memory element 106 may include a non-transitory computer-readable storage medium for implementing one or more aspects of the present disclosure including as a computer-implemented method configured to perform one or more steps/operations described herein. For example, the non-transitory computer-readable storage medium may include instructions that when executed by a computer (e.g., processing element 104), cause the computer to perform one or more steps/operations of the present disclosure. For instance, the memory element 106 may store instructions that, when executed by the processing element 104, configure the computing entity 102 to perform one or more steps/operations described herein.

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language, such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

The computing entity 102 may be embodied by a computer program product which includes non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media such as the volatile memory 202 and/or the non-volatile memory 204.

The computing entity 102 may include one or more I/O elements 114. The I/O elements 114 may include one or more output devices 206 and/or one or more input devices 208 for providing and/or receiving information with a user, respectively. The output devices 206 may include one or more sensory output devices, such as one or more tactile output devices (e.g., vibration devices such as direct current motors, and/or the like), one or more visual output devices (e.g., liquid crystal displays, LEDs, and/or the like), one or more audio output devices (e.g., speakers, and/or the like), and/or the like. The input devices 208 may include one or more sensory input devices, such as one or more tactile input devices (e.g., touch sensitive displays, push buttons, and/or the like), one or more audio input devices (e.g., microphones, and/or the like), and/or the like.

In addition, or alternatively, the computing entity 102 may communicate, via a communication interface 108, with one or more external computing entities such as the external computing entity 112-a. The communication interface 108 may be compatible with one or more wired and/or wireless communication protocols.

For example, such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In addition, or alternatively, the computing entity 102 may be configured to communicate via wireless external communication using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.9 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

The external computing entity 112-a may include an external entity processing element 210, an external entity memory element 212, an external entity communication interface 224, and/or one or more external entity I/O elements 218 that communicate within the external computing entity 112-a via internal communication circuitry, such as a communication bus and/or the like.

The external entity processing element 210 may include one or more processing devices, processors, and/or any other device, circuitry, and/or the like described with reference to the processing element 104. The external entity memory element 212 may include one or more memory devices, media, and/or the like described with reference to the memory element 106. The external entity memory element 212, for example, may include at least one external entity volatile memory 214 and/or external entity non-volatile memory 216. The external entity communication interface 224 may include one or more wired and/or wireless communication interfaces as described with reference to communication interface 108.

In some embodiments, the external entity communication interface 224 may be supported by one or more radio circuitry. For instance, the external computing entity 112-a may include an antenna 226, a transmitter 228 (e.g., radio), and/or a receiver 230 (e.g., radio). Signals provided to and received from the transmitter 228 and the receiver 230, correspondingly, may include signaling information/data in accordance with air interface standards of applicable wireless systems. In this regard, the external computing entity 112-a may be capable of operating with one or more air interface standards, communication protocols, modulation types, and access types. More particularly, the external computing entity 112-a may operate in accordance with any of a number of wireless communication standards and protocols, such as those described above with regard to the computing entity 102.

Via these communication standards and protocols, the external computing entity 112-a may communicate with various other entities using means such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 112-a may also download changes, add-ons, and updates, for instance, to its firmware, software (e.g., including executable instructions, applications, program modules), operating system, and/or the like.

According to one embodiment, the external computing entity 112-a may include location determining embodiments, devices, modules, functionalities, and/or the like. Location determining features may be used, for example, to confirm a location of devices described herein for more accurately identifying or confirming an associated patient, medical care facility, residence, and/or the like. For example, the external computing entity 112-a may include positioning embodiments, such as a location module adapted to acquire, for example, latitude, longitude, geocode, universal time (UTC), date, and/or various other information/data. The location information/data may be determined by triangulating a position of the external computing entity 112-a in connection with a variety of other systems, including cellular towers, Wi-Fi access points, and/or the like. Further, indoor location determining systems of example embodiments may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning embodiments may be used in a variety of settings to determine the location of someone or something within inches or centimeters.

The external entity I/O elements 218 may include one or more external entity output devices 220 and/or one or more external entity input devices 222 that may include one or more sensory devices described herein with reference to the I/O elements 114. In some embodiments, the external entity I/O element 218 may include a user interface (e.g., a display, speaker, and/or the like) and/or a user input interface (e.g., keypad, touch screen, microphone, and/or the like) that may be coupled to the external entity processing element 210.

For example, the user interface may be a user application, browser, and/or similar words used herein interchangeably executing on and/or accessible via the external computing entity 112-a to interact with and/or cause the display, announcement, and/or the like of information/data to a user. The user input interface may include any of a number of input devices or interfaces allowing the external computing entity 112-a to receive data including, as examples, a keypad (hard or soft), a touch display, voice/speech interfaces, motion interfaces, and/or any other input device. In embodiments including a keypad, the keypad may include (or cause display of) the conventional numeric (0-9) and related keys (#, *, and/or the like), and other keys used for operating the external computing entity 112-a and may include a full set of alphabetic keys or set of keys that may be activated to provide a full set of alphanumeric keys. In addition to providing input, the user input interface may be used, for example, to activate or deactivate certain functions, such as screen savers, sleep modes, and/or the like.

### III. Examples of Certain Terms

In some embodiments, the term “vehicle” refers to a mobile object or machine configured to travel or move between various locations. An aerial vehicle may be propelled by one or more propulsion systems, each of which may include one or more motors, one or more propeller systems, one or more rockets, and/or the like. In some examples, an aerial vehicle may transport a payload including one or more objects and/or one or more individuals. An aerial vehicle may be equipped with one or more control systems, such as one or more computing entities, which may be configured to control the movement of the aerial vehicle by communicating one or more control signals to one or more propulsion systems of the aerial vehicle. Additionally, or alternatively, the one or more control systems may be configured to control one or more systems of the aerial vehicle other than the one or more propulsion systems, such as a tether assembly and/or a fire extinguishing device.

In some examples, an aerial vehicle and/or a control system of an aerial vehicle may be controlled by or may receive one or more inputs from one or more individuals, such as a pilot or a driver who may be located aboard the aerial vehicle (e.g., the aerial vehicle may be manned) or remotely. In some examples, an aerial vehicle may be autonomous and/or unmanned. For example, an autonomous vehicle may navigate and/or perform one or more other operations based on information received by one or more sensor systems and/or information determined by one or more processors of the aerial vehicle. Such information may be received, determined, generated, and/or processed without human intervention or with a threshold level of human intervention, such as human intervention to initialize and/or terminate one or more operations (e.g., a human may power on and/or launch an aerial vehicle and subsequently allow the aerial vehicle to operate autonomously).

As described herein, an aerial vehicle may be an aircraft, a spacecraft, a satellite, an unmanned aerial vehicle (UAV), unmanned aircraft system (UAS), and/or the like. An aerial vehicle may be equipped with one or more systems, such as one or more computing devices. In some examples, an aerial vehicle may communicate with one or more other vehicles and/or devices via a wireless network. For example, a computing entity of an aerial vehicle may include one or more communication interfaces, which may enable the aerial vehicle to wirelessly communicate with one or more other vehicles and/or computing entities.

An aerial vehicle may include one or more sensors, which may be utilized to generate data, such as image data (e.g., visible light image data, infrared image data, thermal image data, and/or the like). In some examples, the image data may be representative of an environment in which the aerial vehicle is operating and/or one or more objects and/or phenomenon (e.g., a fire, weather phenomenon) within a range of the one or more sensors. In some examples, one or more aerial vehicle control systems may utilize image data generated by the one or more sensors for control and/or navigation of the aerial vehicle. For example, one or more aerial vehicle control systems may be activated, deactivated, or otherwise adjusted based on the image data.

In some examples, an aerial vehicle may include one or more navigational systems and/or sensors. For example, an aerial vehicle may include one or more accelerometers, one or more global positioning system (GPS) devices, and/or the like. The one or more navigational systems and/or sensors may output navigational information (e.g., location information, speed information, velocity information), which may be utilized by one or more processors to perform one or more operations, such as one or more control operations. In some examples, the one more navigational systems may be utilized to control an aerial vehicle in the presence of one or more destabilizing forces, such as environmental forces (e.g., wind forces) and/or forces generated by the expulsion of fire suppressant.

In some examples, an aerial vehicle may include one or more propulsion systems, which may enable the aerial vehicle to move in one or more directions. For example, the one or more propulsion systems may control vehicle movement in a horizontal direction, a vertical direction, a rotational direction, and/or the like. The one or more propulsion systems may be configured to cause the aerial vehicle to travel to one or more locations. The one or more locations may be determined by one or more processors of the aerial vehicle and/or one or more other processors (e.g., one or more cloud-based processors, one or more processors of one or more other vehicles, one or more processors of a ground-based control system).

In one illustrative example, a propulsion system of an aerial vehicle may include one or more propeller systems and/or any other type of propulsion system that generates airflow, such as a downdraft. For example, a crewed or uncrewed aircraft may include one or more propeller systems, which may generate one or more downdrafts. In some examples, however, such as in firefighting applications, it may be undesirable for a downdraft generated by one or more propulsion systems to come into contact with a fire. For example, if an aerial vehicle approaches a fire too closely, a downdraft from the aerial vehicle may fuel and increase a size of the fire. Accordingly, the techniques described herein may enable an aerial vehicle to remain at a safe distance from a fire (e.g., a threshold distance), such that the downdraft from the aircraft does not exacerbate the fire. For example, an aerial vehicle may receive and/or determine a fire location and travel to a location based on the fire location. The location may be a threshold distance from the fire location, which may prevent a downdraft of the aircraft from exacerbating the fire. In some examples, one or more processors may determine the threshold distance based on one or more propulsion parameters (e.g., an amount of thrust generated by one or more propulsion systems of an aerial vehicle). For example, one or more processors may determine a threshold distance that is equivalent to and/or based on an estimated range of a downdraft for the aircraft.

In some embodiments, the term “tether assembly” refers to one or more components configured to physically couple two or more objects. A tether assembly may include a tether, one or more mounting devices, and/or one or more winding devices for extending and retracting the tether. For example, a winch may be attached to a fire extinguishing device, a tether may be attached to the winch, and the tether may be attached to an aerial vehicle. In another illustrative configuration, a winch may be attached to an aerial vehicle, a tether may be attached to the winch, and the tether may be attached to a fire extinguishing device. As described herein, a tether assembly, an aerial vehicle, and/or a fire extinguishing device may include one or more computing entities, which may control the tether assembly (e.g., control the extension and retraction of the tether) based on one or more control signals, which may be generated by one or more processors.

In some embodiments, the term “retractable tether” refers to a subcomponent of a tether assembly that couples the tether assembly with a payload, such as a fire extinguisher device. A retractable tether may include any type of rope, chain, linkage, and/or wire. In some examples, a retractable tether may include one or more electrical wires for the delivery of power and/or communications to and/or from a payload of the retractable tether, such as a fire extinguishing device. In such examples, the retractable tether may include one or more load bearing tethers in addition to the one or more electrical wires. In some other examples, the one or more electrical wires may be utilized as load bearing tethers. In some examples, a length of a retractable tether may be based on an estimated height of a tree canopy (e.g., greater than 50 meters), such that the retractable tether may extend a payload through a tree canopy while an aerial vehicle supporting the retractable tether avoids contact with the tree canopy.

In some embodiments, the term “fire extinguishing device” refers to a device configured to release, discharge, and/or expel one or more fire suppressants. In some examples, a fire extinguishing device may be coupled with a retractable tether and/or a tether assembly. A fire extinguishing device may include one or more winches, a housing, one or more fire suppressant reservoirs (e.g., one or more flame retardant reservoirs), one or more flow regulators, one or more nozzles, one or more propulsion systems (e.g., one or more ducted fans), one or more sensors (e.g., one or more video and/or thermal cameras), one or more computing entities, and/or one or more power systems (e.g., one or more batteries). In some examples, a housing of the fire extinguishing device may be formed in the shape of a wedge and/or have a conical geometry, which may enable the fire extinguishing device to travel through one or more obstacles (e.g., tree branches) without getting stuck.

A fire extinguishing device may include one or more sensors, which may be utilized to generate data, such as image data (e.g., visible light image data, infrared image data, thermal image data, and/or the like). In some examples, the image data may be representative of an environment in which the fire extinguishing device is operating and/or one or more objects and/or phenomenon (e.g., a fire, weather phenomenon) within a range of the one or more sensors. In some examples, one or more control systems may utilize image data generated by the one or more sensors for control and/or navigation of the fire extinguishing device. For example, one or more propulsion systems of the fire extinguishing device and/or a winch controlling extension and retraction of a tether may be activated, deactivated, or otherwise adjusted based on the image data.

In some examples, a fire extinguishing device may include one or more navigational systems and/or sensors. For example, a fire extinguishing device may include one or more accelerometers, one or more GPS devices, and/or the like. The one or more navigational systems and/or sensors may output navigational information (e.g., location information, speed information, velocity information), which may be utilized by one or more processors to perform one or more operations, such as one or more control operations. In some examples, the one more navigational systems may be utilized to control the fire extinguishing device in the presence of one or more destabilizing forces, such as environmental forces (e.g., wind forces) and/or forces generated by the expulsion of fire suppressant. For example, one or more accelerometers may output one or more signals indicating displacement of the fire extinguishing device (e.g., due to wind forces). In response to receiving the one or more signals, one or more processors may cause one or more propulsion systems of the fire extinguishing device to be activated, thereby stabilizing the fire extinguishing device.

In some examples, a fire extinguishing device may include one or more propulsion systems (e.g., one or more ducted fans), which may enable the fire extinguishing device to move in one or more directions. For example, the one or more propulsion systems may control movement of the fire extinguishing device in a horizontal direction, a vertical direction, a rotational direction, and/or the like. The one or more propulsion systems may be configured to cause the fire extinguishing device to travel to one or more locations (e.g., one or more fire extinguishing device approach locations). The one or more locations may be determined by one or more processors of the fire extinguishing device and/or one or more other processors (e.g., one or more cloud-based processors, one or more processors of one or more aerial vehicles, one or more processors of a ground-based control system).

In some embodiments, the term “propulsion system” refers to a system capable of generating thrust or other propulsive forces that convey an aerial vehicle, object, and/or device in one or more directions. A propulsion system may include one or more propellers, one or more fan blades, and/or the like. As one illustrative example, an aerial vehicle, such as a crewed or uncrewed aircraft, may be propelled by one or more propulsion systems comprising one or more propellers. As another illustrative example, a fire extinguishing device may be propelled by one or more propulsion systems comprising one or more propellers (e.g., one or more ducted fans). Although some examples described herein refer to propulsion systems that cause an aerial vehicle and/or device to be conveyed from one location to another location, a propulsion system may also cause an aerial vehicle and/or a device to be stabilized or to otherwise remain stationary for a period of time at a single location. For example, one or more ducted fans of a fire extinguishing device may be activated or otherwise controlled to cause the fire extinguishing device to remain stationary for a time period (e.g., while fire suppressant is being expelled, while the tether is lowered, and/or the like). As another illustrative example, one or more propeller systems of an aerial vehicle may be activated or otherwise controlled to cause the aerial vehicle to remain stationary for a time period (e.g., while the fire extinguishing device is being lowered and/or expelling fire suppressant).

In some embodiments, the term “fire location” refers to a first location associated with a fire. A fire location may encompass a region (e.g., a two-dimensional region, a three-dimensional region) associated with a fire or a point associated with a fire. In some examples, a fire location may be determined (e.g., by one or more processors) based on thermal imaging data. In some examples, a fire location may be based on one or more temperature measurements for a region. For example, a point or a region determined to have a highest temperature when compared to one or more other points or regions may be selected as a fire location. In some examples, one or more nozzles of a fire extinguishing device may be aimed at a fire location for the application of fire suppressant.

In some embodiments, the term “vehicle approach location” refers to a second location associated with a fire. A location may be a location that one or more aerial vehicles travel to in order to lower a fire extinguishing device. For example, an aerial vehicle may travel to a location and remain stationary at the location for a period of time while the aerial vehicle lowers a fire extinguishing device to apply fire suppressant to a fire. In some examples, a location may be a threshold distance from a fire location (e.g., so that one or more propulsion systems of the aerial vehicle do not fan the flames of the fire, so that the aerial vehicle is not burned or otherwise adversely affected by heat from the fire).

In some embodiments, the term “fire extinguishing device approach location” refers to a third location associated with a fire. A fire extinguishing device approach location may be a location that a fire extinguishing device is lowered to in order to apply fire suppressant to a fire. For example, an aerial vehicle may travel to a location and remain stationary at the location for a period of time while the aerial vehicle lowers a fire extinguishing device to a fire extinguishing device approach location. In some examples, a fire extinguishing device approach location may be adjacent to a fire location. In some examples, a fire extinguishing device approach location may be a threshold distance from a fire location (e.g., so that the fire extinguishing device is not burned or otherwise adversely affected by heat from the fire).

In some embodiments, the term “fire suppressant” refers to a substance used to control, extinguish, suppress, and/or prevent fires. A fire suppressant may include water, foam, one or more dry chemicals, one or more gases, and/or any other type of substance designed to cool, smother, or interrupt chemical reactions that sustain fire. As described herein, a fire extinguishing device may include a reservoir (e.g., a flame retardant reservoir), which may be filled with one or more fire suppressants. The fire extinguishing device may then deploy or otherwise expel the fire suppressant via one or more nozzles (e.g., based on a control signal that causes one or more valves to be opened).

In some embodiments, the term “stabilization operation” refers to one or more actions that may be performed to stabilize an object, such as an aerial vehicle, a fire extinguishing device, a tether, and/or the like. In some examples, performing a stabilization operation may include activating or otherwise controlling one or more propulsion systems of a fire extinguishing device to stabilize the fire extinguishing device. In some examples, the one or more propulsion systems may be activated or otherwise controlled based on information indicative of one or more forces acting on the fire extinguishing device, such as the force generated by the expulsion of fire suppressant form the fire extinguishing device. In such examples, the information indicative of one or more forces acting on the fire extinguishing device may include one or more fire suppressant parameters, which may indicate that fire suppressant is being expelled from the fire extinguishing device or an intensity at which fire suppressant is expelled from the fire extinguishing device. In such examples, one or more propulsion parameters may be updated or configured based on one or more fire suppressant parameters.

In some embodiments, the term “fire suppressant parameter” refers to a value or an indicator of a configuration associated with expelling fire suppressant from a fire extinguishing device. For example, a binary fire suppressant parameter may indicate whether a fire suppressant valve is open or closed and/or whether or not fire suppressant is being expelled from a fire extinguishing device. In some examples, a fire suppressant parameter may indicate a velocity or intensity (e.g., qualitative or quantitative) at which a fire suppressant is expelled from a fire extinguishing device. As described herein, a fire suppressant parameter may be indicated using one or more values.

In some embodiments, the term “propulsion parameter” refers to a value or an indicator of a configuration associated with one or more propulsion systems. For example, a binary propulsion parameter may indicate whether one or more propulsion systems are activated or deactivated, or a degree of power provided to and/or by one or more propulsion systems. In some examples, a propulsion parameter may indicate a thrust or power (e.g., qualitative or quantitative) provided by one or more propulsion systems. As described herein, propulsion parameter may be indicated using one or more values.

In some embodiments, the term “downdraft value” refers to a value indicative of an amount of downdraft generated by one or more propulsion systems. A downdraft value may be a volume flow rate, a velocity, a distance, or any other type of measurement or characterization of an intensity and/or geometry of a downdraft. As one illustrative example, a downdraft value may indicate a distance from one or more propulsion systems at which a downdraft is present. As described herein a threshold distance between a location and a fire location may be determined based on one or more downdraft values. In some examples, one or more processors may determine the threshold distance based on the one or more downdraft values.

In some embodiments, the term “sensor” refers to a device or component that detects and/or outputs data (e.g., one or more values) in response to various stimuli. The data output by a sensor may be utilized by one or more processors to make one or more determinations and/or to generate other data. For example, one or more processors may receive thermal imaging data output by one or more sensors of a fire extinguishing device. The one or more processors may then determine a fire location based on the thermal imaging data. As described herein, the term “sensor” may refer to any type of sensor such as a vision-based sensor (e.g., a video camera, a thermal camera), an accelerometer, a GPS sensor, an altimeter, an ultrasonic sensor, a radar sensor, a temperature sensor, a humidity sensor, and/or the like.

In some embodiments, the term “sensor data” refers to data generated, detected, and/or output by one or more sensors. For example, a temperature sensor may detect and/or output sensor data, such as one or more temperature values. As described herein, sensor data may be utilized to perform one or more operations and/or to make one or more determinations (e.g., by one or more processors). For example, one or more processors may receive sensor data, such as acceleration data, and determine a position and/or acceleration of a device and/or vehicle based on the sensor data.

In some embodiments, the term “lightning strike data” refers to data indicative of information associated with one or more lightning strikes. For example, lightning strike data may indicate one or more geographical locations of one or more lightning strikes. In some examples, lightning strike data may indicate one or more time instances at which one or more lightning strikes have occurred. For example, the one or more time instances may be linked to or may otherwise correspond to the one or more geographical locations. In some examples, lightning strike data may be utilized to determine a fire location (e.g., in combination with moisture-based fire risk data). In some examples, lightning strike data may be utilized to determine one or more potential fire locations, which may be further investigated (e.g., by one or more aerial vehicles) to determine if a fire exists in such a location. In some examples, the one or more aerial vehicles may not include a fire extinguishing device and may relay fire confirmation information to one or more aerial vehicles including a fire extinguishing device. In such examples, the one or more aerial vehicles that confirm whether a fire exists at a potential fire location may be smaller and/or more efficient than one or more aerial vehicles that include a fire extinguishing device, which may conserve resources.

In some embodiments, the term “moisture-based fire risk data” refers to data indicative of fire risk based on historical moisture or precipitation values. In some examples, moisture-based fire risk data may correspond to one or more specific regions or geographic areas. Moisture-based fire risk data may include one or more fire risk values corresponding to one or more geographical areas. For example, a moisture-based fire risk value for a region that has experienced drought conditions over a time period may be higher than a moisture-based fire risk value for a region that has experienced a higher amount of precipitation over a time period.

In some embodiments, the term “wedge structure” refers to a structure or shape capable of displacing one or more obstacles. Through one or more applied forces, a wedge structure may move through one or more obstacles in a path of travel for the wedge structure. In some examples, a wedge structure may have a pyramidal or a conical shape. As described herein, a fire extinguishing device may include or otherwise be formed in the shape of one or more wedge structures. For example, a fire extinguishing device may be formed in the shape of a bicone or an octahedron. Such a geometry may enable the fire extinguishing device to displace one or more obstacles, such as one or more tree branches as the fire extinguishing device is positioned.

### IV. Overview

Lightning strikes lead to seventy percent of all areas burned in the United States. Some fires ignite within forests on the ground due to combustible forest litter and others ignite along the length of tree trunks or even in the canopy. If the ignition is extinguished early enough, fire spread is avoided. As wildfires typically double in size every few minutes during their early spread, early detection and suppression could be highly beneficial. Once an ignition source is located, rapid mitigation would prevent spread. For remote areas, existing technologies for rapidly extinguishing fires include the use of conventional aerial vehicles such as drones or helicopters, which can travel to an ignition site more quickly than land-based vehicles. This is especially true in terrains with no nearby roads and where the vegetation, or the landscape, is difficult to traverse on the ground. While conventional aerial vehicles may approach the ignition site, they may not be able to get sufficiently close to extinguish the fire for two reasons. First, conventional aerial vehicles that use rotors to hover around the ignition site may create substantial propeller downwash air flow that enhances the fire. Second, for fires in forests, the aerial vehicle may not have space to sufficiently approach the fire for targeting application of a fire suppressant.

The present disclosure provides a high-precision, autonomously guided, tethered fire extinguishing device connected to a station holding vehicle. The system may be used in dense forests to extinguish fires on the ground as well as at any position along a tree trunk. The system does not fan the fire as it supports its weight through the tether, while the aerial vehicle that holds the tether is sufficiently far to generate only insignificant airflow at the ignition site. The firefighting system of the present disclosure may be utilized in a variety of environments, such as grasslands, urban areas, and forests. Additionally, the system is durable and capable of contacting and displacing tree branches and limbs.

As described herein, the fire extinguishing device may include a tether that is connected to a station holding vehicle capable of carrying the weight of the fire extinguishing device. The tether may have a length that is long enough to penetrate through the forest canopy to the ground (e.g., the tether may be 50 meters or longer). The fire extinguishing device may include a self-contained winch configured to lower the fire extinguishing device within a close proximity of the ignition and/or fire location and raise it back to up the aerial vehicle. The fire extinguishing device may include a reservoir of flame retardant, which may be pressurized. In some examples, the fire extinguishing device may include an articulating nozzle to spray the retardant towards the ignition and/or fire location.

The fire extinguishing device may include a propulsion system that can move the fire extinguishing device in both translation in the horizontal plane and rotation about a vertical axis to position the fire extinguishing device close to the ignition and/or fire location. In some examples, the propulsion system may counteract the thrust caused by the spray nozzle. Additionally, or alternatively, the propulsion system of the fire extinguishing device may not fan the flames. In some examples, the propulsion system may include one or more ducted fans, which may provide the thrust required for precision maneuvers.

In some examples, the fire extinguishing device may include one or more video cameras to help guide the fire extinguishing device through the canopy and aim the nozzle towards the fire and/or ignition location. In some examples, the fire extinguishing device may include one or more lights to illuminate the surrounding obstacles for precision guidance. Additionally, or alternatively, the fire extinguishing device may include one or more thermal cameras to help precisely point the spray nozzle for the most effective extinguishing. In some examples, the fire extinguishing device may include a release mechanism in case the fire extinguishing device gets snagged in a tree. For example, the release system may enable the fire extinguishing device to detach from the tether and/or vehicle. In some examples, the fire extinguishing device may be autonomous. For example, the fire extinguishing device may autonomously navigate and direct the nozzle for accurate aiming of fire suppressant.

In some examples, the fire extinguishing device may include a fireproof and durable housing to protect the fire extinguishing device from heat damage and impact from tree branches. The housing may have a shape that will not snag on tree limbs while it lowers itself down to the ignition and/or fire location. In some examples, the fire extinguishing device control system (e.g., the autonomous control system) may utilize input from the one or more cameras to determine a fire location and the environment surrounding the fire extinguishing device. Additionally, or alternatively, one or more systems of the fire extinguishing device may detect or otherwise determine one or more environmental factors, such as wind and predicted fire spread direction. Such information may be utilized by the fire extinguishing device to determine an adequate movement trajectory and spraying strategy.

Once a fire has been located, the fire extinguishing device may be transported to the location of the fire by an aerial vehicle. The aerial vehicle may suspend the fire extinguishing device below the aerial vehicle, which may be configured to hover at a height that is a safe distance from the fire (e.g., so as not to fan the flames). The height may be on the order of 50 meters (e.g., above the tree canopy). A winch in the fire extinguishing device may be activated to lower the fire extinguishing device through the canopy. The fire extinguishing device may be guided by or otherwise receive environmental imaging data from downward facing cameras. For example, data from motion algorithms that run on an on-board computer help guide the fire extinguishing device through the canopy and towards the fire.

Internally ducted fans move and rotate the fire extinguishing device to avoid tree branches. The shape of the fire extinguishing device is wedge shaped, both for lowering and raising it through the cluttered environment. The housing of the fire extinguishing device is robust and protects it from damage during contact with branches and heat from the fire. Once the fire extinguishing device is positioned for optimal extinguishing, the flame retardant stored onboard is sprayed at the fire. Thrust caused by the spray is counteracted by the thrust from the ducted fans so that persistent, precision targeting is possible. Rotating the fire extinguishing device back and forth is accomplished via the ducted fans. Smoke caused by the fire extinguishing blocks visibility of traditional color cameras, but thermal cameras see through the smoke and maintain continual observation until the fire is extinguished. Once the fire is extinguished or the flame-retardant tank is empty the fire extinguishing device is winched back up to the aerial vehicle using upward facing cameras to pick its path through the canopy. Once at the aerial vehicle, the fire extinguishing device is flown back to the ground station for refill and readied for a subsequent mission.

In conventional systems, propeller downwash tends to fan the flames thus increasing the intensity of fires. Any contact with even small limbs will cause conventional aircraft to crash. Conventional aircraft capable of flying in wooded areas have limited payload capacity. The overall width of the aircraft, from propeller tip to propeller tip, to carry a meaningful amount of fire retardant, is substantial and therefore makes it too wide to navigate the cluttered environment of a forest. If a conventional aircraft disperses flame retardant above the tree canopy it will not effectively reach the forest floor. Conventional ground-based firefighting systems, including those with wheel and legged modalities, would have difficulty managing the terrain in steep, rocky, and brush covered environments. Human response with ground-based vehicles or on foot would have difficulty managing the terrain in steep, rocky, and brush covered environments. If an ignition source is located high on a tree truck or within a canopy, conventional systems may not be capable of reaching such an ignition location. Additionally, conventional systems that utilize full-scale helicopters (e.g., piloted helicopters) are expensive and require extensive and routine inspection and/or maintenance. In some examples, such conventional helicopter systems may also create larger downdrafts that fan the flames and intensify fire spread.

Examples of technologically advantageous embodiments of the present disclosure include techniques for more precisely and effectively mitigating fire spread using tethered fire extinguishing devices. The described techniques enable improved firefighting response time, improved fire detection speed, improve accuracy of fire suppressant placement, and reduced fire growth otherwise caused by downdraft from an aerial vehicle. Other technical improvements and advantages may be realized by one of ordinary skill in the art.

### V. Example System Frameworks

As indicated, various embodiments of the present disclosure make important technical contributions to the field of firefighting. In particular, systems and methods are disclosed herein that enable aerial firefighting vehicles to deploy fire extinguishing devices while remaining at a safe operating distance from a fire. When compared to traditional techniques, the techniques described herein provide improved accuracy of fire suppressant placement and improved firefighting response time, among other advantages.

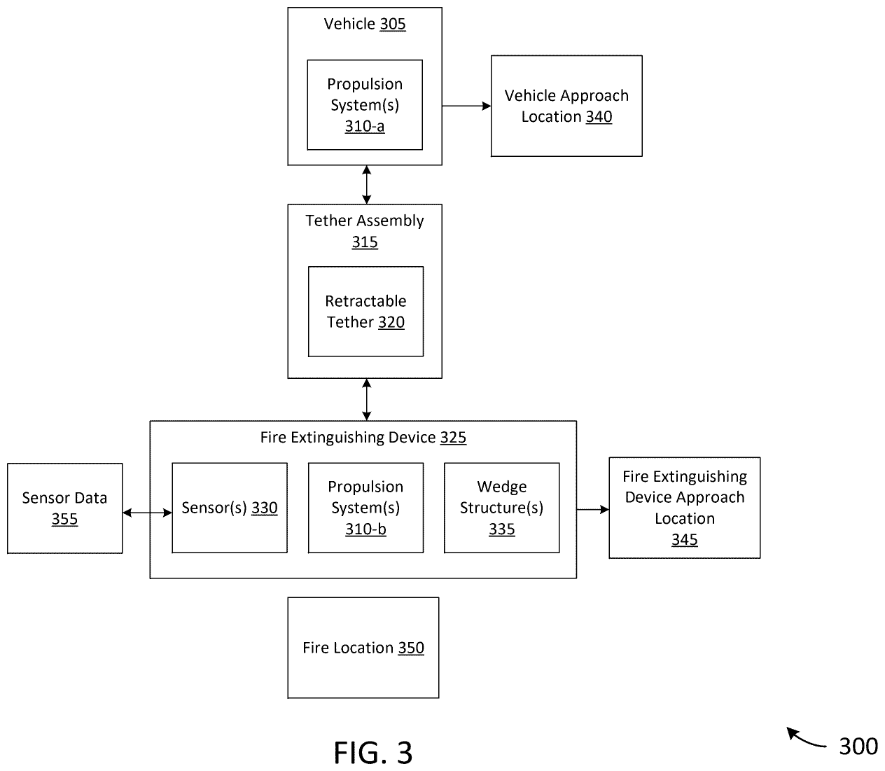

FIG. 3 illustrates a data flow diagram 300 in accordance with some embodiments discussed herein. The data flow diagram 300 may illustrate examples of one or more devices, components, and/or locations as described herein, such as an aerial vehicle 305, one or more propulsion systems 310, a tether assembly 315, a retractable tether 320, a fire extinguishing device 325, one or more sensors 330, one or more wedge structures 335, a location 340, a fire extinguishing device approach location 345, and a fire location 350. Additionally, or alternatively, the data flow diagram 300 may illustrate one or more operations, which may be performed by any one or more of the devices and/or components. The data flow diagram 300 may provide one or more examples of data types, such as sensor data 355, which may be generated, communicated, input, output, and/or the like by any one or more of the devices and/or components described herein, such as the one or more sensors 330.

In one embodiment, an aerial vehicle 305 may include a propulsion system 310-a. The aerial vehicle 305 may be configured to travel to a location 340 associated with a fire. In some examples, the location 340 may be a threshold distance from a fire location 350. In some examples, an aerial vehicle 305 may be a mobile object or machine configured to travel or move between various locations. An aerial vehicle 305 may be propelled by one or more propulsion systems, each of which may include one or more motors, one or more propeller systems, one or more rockets, and/or the like. In some examples, an aerial vehicle 305 may transport a payload including one or more objects and/or one or more individuals. An aerial vehicle 305 may be equipped with or otherwise include one or more control systems (not shown), such as one or more computing entities, which may be configured to control the movement of the aerial vehicle 305 by communicating one or more control signals to one or more propulsion systems 310-a of the aerial vehicle 305. Additionally, or alternatively, the one or more control systems may be configured to control one or more systems of and/or associated with the aerial vehicle 305 other than the one or more propulsion systems 310-a, such as a tether assembly 315 and/or a fire extinguishing device 325.

In some examples, an aerial vehicle 305 and/or a control system of an aerial vehicle 305 may be controlled by or may receive one or more inputs from one or more individuals, such as a pilot or a driver. In some other examples, an aerial vehicle 305 may be autonomous or unmanned. For example, an autonomous vehicle may navigate and/or perform one or more other operations based on information received by one or more sensor systems and/or information determined by one or more processors of the aerial vehicle 305. Such information may be received, determined, generated, and/or processed without human intervention or with a threshold level of human intervention, such as human intervention to initialize and/or terminate one or more operations (e.g., a human may power on and/or launch an aerial vehicle 305 and subsequently allow the aerial vehicle 305 to operate autonomously).

As described herein, an aerial vehicle 305 may be an aircraft, a spacecraft, a satellite, an unmanned cargo vehicle, and/or the like. An aerial vehicle 305 may be equipped with one or more systems, such as one or more computing devices. In some examples, an aerial vehicle 305 may communicate with one or more other vehicles (not shown) and/or devices via a wireless network. For example, a computing entity of an aerial vehicle 305 may include one or more communication interfaces, which may enable the aerial vehicle 305 to wirelessly communicate with one or more other vehicles and/or computing entities.

An aerial vehicle 305 may include one or more sensors 330 (not shown), which may be utilized to generate data, such as image data (e.g., visible light image data, infrared image data, thermal image data, and/or the like). In some examples, the image data may be representative of an environment in which the aerial vehicle 305 is operating and/or one or more objects and/or phenomenon (e.g., a fire, weather phenomenon) within a range of the one or more sensors 330. In some examples, one or more aerial vehicle control systems may utilize image data generated by the one or more sensors 330 for control and/or navigation of the aerial vehicle 305. For example, one or more aerial vehicle control systems may be activated, deactivated, or otherwise adjusted based on the image data.

In some examples, an aerial vehicle 305 may include one or more navigational systems and/or sensors 330. For example, an aerial vehicle 305 may include one or more accelerometers, one or more global positioning system (GPS) devices, and/or the like. The one or more navigational systems and/or sensors 330 may output navigational information (e.g., location information, speed information, velocity information), which may be utilized by one or more processors to perform one or more operations, such as one or more control operations. In some examples, the one more navigational systems may be utilized to control an aerial vehicle 305 in the presence of one or more destabilizing forces, such as environmental forces (e.g., wind forces) and/or forces generated by the expulsion of fire suppressant.

In some examples, an aerial vehicle 305 may include one or more propulsion systems 310-a, which may enable the aerial vehicle 305 to move in one or more directions. For example, the one or more propulsion systems 310-a may control vehicle movement in a horizontal direction, a vertical direction, a rotational direction, and/or the like. The one or more propulsion systems 310-a may be configured to cause the aerial vehicle 305 to travel to one or more locations. The one or more locations may be determined by one or more processors of the aerial vehicle 305 and/or one or more other processors (e.g., one or more cloud-based processors, one or more processors of one or more other vehicles, one or more processors of a ground-based control system).

In one illustrative example, a propulsion system of an aerial vehicle 305 may include one or more propeller systems and/or any other type of propulsion system that generates airflow, such as a downdraft. For example, an aerial vehicle may include one or more propeller systems, which may generate one or more downdrafts. In some examples, however, such as in firefighting applications, it may be undesirable for a downdraft generated by one or more propulsion systems 310-a to come into contact with a fire. For example, if an aerial vehicle approaches a fire too closely, a downdraft from the aerial vehicle may fuel and increase a size of the fire.

Accordingly, the techniques described herein may enable an aerial vehicle 305, such as an aerial vehicle, to remain at a safe distance from a fire (e.g., a threshold distance), such that the downdraft from the aerial vehicle does not exacerbate the fire. For example, an aerial vehicle may receive and/or determine a fire location 350 and travel to a location 340 based on the fire location 350. The location 340 may be a threshold distance from the fire location 350, which may prevent a downdraft of the aerial vehicle from exacerbating the fire. In some examples, one or more processors may determine the threshold distance based on one or more propulsion parameters (e.g., an amount of thrust generated by one or more propulsion systems 310-a of an aerial vehicle 305). For example, one or more processors may determine a threshold distance that is equivalent to and/or based on an estimated range of a downdraft for the aerial vehicle.

In some examples, a fire location 350 may be a first location associated with a fire. A fire location 350 may encompass a region (e.g., a two-dimensional region, a three-dimensional region) associated with a fire or a point associated with a fire. In some examples, a fire location 350 may be determined (e.g., by one or more processors) based on thermal imaging data. In some examples, a fire location 350 may be based on one or more temperature measurements for a region. For example, a point or a region determined to have a highest temperature when compared to one or more other points or regions may be selected as a fire location 350. In some examples, one or more nozzles of a fire extinguishing device 325 may be aimed at a fire location 350 for the application of fire suppressant.

In some examples, a location 340 may be a second location associated with a fire. A location 340 may be a location that one or more aerial vehicles 305 travel to in order to lower a fire extinguishing device 325. For example, an aerial vehicle may travel to a location 340 and remain stationary at the location 340 for a period of time while the aerial vehicle lowers a fire extinguishing device 325 to apply fire suppressant to a fire. In some examples, a location 340 may be a threshold distance from a fire location 350 (e.g., so that one or more propulsion systems 310-a of the aerial vehicle 305 do not fan the flames of the fire, so that the aerial vehicle 305 is not burned or otherwise adversely affected by heat from the fire).

In one embodiment, a tether assembly 315 may be configured to extend a retractable tether 320 based at least in part on the aerial vehicle 305 travelling to the location 340. In some examples, a tether assembly 315 may include one or more components configured to physically couple two or more objects. A tether assembly 315 may include a tether, one or more mounting devices, and/or one or more winding devices for extending and retracting the tether. For example, a winch may be attached to a fire extinguishing device 325, a tether may be attached to the winch, and the tether may be attached to an aerial vehicle 305. In another illustrative configuration, a winch may be attached to an aerial vehicle 305, a tether may be attached to the winch, and the tether may be attached to a fire extinguishing device 325. As described herein, a tether assembly 315 may include one or more computing entities, which may control the tether assembly 315 (e.g., control the extension and retraction of the tether) based on one or more control signals, which may be generated by one or more processors.

In some examples, a retractable tether 320 may be a subcomponent of a tether assembly 315 that couples the tether assembly 315 with a payload, such as a fire extinguisher device. A retractable tether 320 may include any type of rope, chain, linkage, and/or wire. In some examples, a retractable tether 320 may include one or more electrical wires for the delivery of power and/or communications to and/or from a payload of the retractable tether 320, such as a fire extinguishing device 325. In such examples, the retractable tether 320 may include one or more load bearing tethers in addition to the one or more electrical wires. In some other examples, the one or more electrical wires may be utilized as load bearing tethers. In some examples, a length of a retractable tether 320 may be based on an estimated height of a tree canopy (e.g., greater than 50 meters), such that the retractable tether 320 may extend a payload through a tree canopy while an aerial vehicle supporting the retractable tether 320 avoids contact with the tree canopy.

In one embodiment, a fire extinguishing device 325 may be coupled to the tether assembly 315 and may comprise a propulsion system 310-b. The fire extinguishing device 325 may be configured to expel a fire suppressant towards the fire and perform one or more stabilization operations using the propulsion system 310-b based at least in part on expelling the fire suppressant. In some examples, a fire extinguishing device 325 may be a device configured to release, discharge, and/or expel one or more fire suppressants. In some examples, a fire extinguishing device 325 may be coupled with a retractable tether 320 and/or a tether assembly 315. A fire extinguishing device 325 may include one or more winches, a housing, one or more fire suppressant reservoirs (e.g., one or more flame retardant reservoirs), one or more flow regulators, one or more nozzles, one or more propulsion systems 310-b (e.g., one or more ducted fans), one or more sensors 330 (e.g., one or more video and/or thermal cameras), one or more computing entities, and/or one or more power systems (e.g., one or more batteries). In some examples, a housing of the fire extinguishing device 325 may be formed in the shape of a wedge and/or have a conical geometry, which may enable the fire extinguishing device 325 to travel through one or more obstacles (e.g., tree branches) without getting stuck.

A fire extinguishing device 325 may include one or more sensors 330, which may be utilized to generate data, such as image data (e.g., visible light image data, infrared image data, thermal image data, and/or the like). In some examples, the image data may be representative of an environment in which the fire extinguishing device 325 is operating and/or one or more objects and/or phenomenon (e.g., a fire, weather phenomenon) within a range of the one or more sensors 330. In some examples, one or more control systems may utilize image data generated by the one or more sensors 330 for control and/or navigation of the fire extinguishing device 325. For example, one or more propulsion systems 310-b of the fire extinguishing device 325 and/or a winch controlling extension and retraction of a tether may be activated, deactivated, or otherwise adjusted based on the image data.

In some examples, a fire extinguishing device 325 may include one or more navigational systems and/or sensors 330. For example, a fire extinguishing device 325 may include one or more accelerometers, one or more GPS devices, and/or the like. The one or more navigational systems and/or sensors 330 may output navigational information (e.g., location information, speed information, velocity information), which may be utilized by one or more processors to perform one or more operations, such as one or more control operations. In some examples, the one more navigational systems may be utilized to control the fire extinguishing device 325 in the presence of one or more destabilizing forces, such as environmental forces (e.g., wind forces) and/or forces generated by the expulsion of fire suppressant. For example, one or more accelerometers may output one or more signals indicating displacement of the fire extinguishing device 325 (e.g., due to wind forces). In response to receiving the one or more signals, one or more processors may cause one or more propulsion systems 310-b of the fire extinguishing device 325 to be activated, thereby stabilizing the fire extinguishing device 325.

In some examples, a fire extinguishing device 325 may include one or more propulsion systems 310-b (e.g., one or more ducted fans), which may enable the fire extinguishing device 325 to move in one or more directions. For example, the one or more propulsion systems 310-b may control movement of the fire extinguishing device 325 in a horizontal direction, a vertical direction, a rotational direction, and/or the like. The one or more propulsion systems 310-b may be configured to cause the fire extinguishing device 325 to travel to one or more locations (e.g., one or more fire extinguishing device approach locations 345). The one or more locations may be determined by one or more processors of the fire extinguishing device 325 and/or one or more other processors (e.g., one or more cloud-based processors, one or more processors of one or more aerial vehicles 305, one or more processors of a ground-based control system).

In some examples, a propulsion system may be a system capable of generating thrust or other propulsive forces that convey an aerial vehicle 305, object, and/or device in one or more directions. A propulsion system may include one or more propellers, one or more fan blades, and/or the like. As one illustrative example, an aerial vehicle 305, such as an aerial vehicle, may be propelled by one or more propulsion systems 310 comprising one or more propellers. As another illustrative example, a fire extinguishing device 325 may be propelled by one or more propulsion systems 310 comprising one or more propellers (e.g., one or more ducted fans).

Although some examples described herein refer to propulsion systems 310 that cause an aerial vehicle 305 and/or device to be conveyed from one location to another location, a propulsion system may also cause an aerial vehicle 305 and/or a device to be stabilized or to otherwise remain stationary for a period of time at a single location. For example, one or more ducted fans of a fire extinguishing device 325 may be activated or otherwise controlled to cause the fire extinguishing device 325 to remain stationary for a time period (e.g., while fire suppressant is being expelled, while the tether is lowered, and/or the like). As another illustrative example, one or more propeller systems of an aerial vehicle may be activated or otherwise controlled to cause the aerial vehicle to remain stationary for a time period (e.g., while the fire extinguishing device 325 is being lowered and/or expelling fire suppressant).

In some examples, a fire suppressant may be a substance used to control, extinguish, suppress, and/or prevent fires. A fire suppressant may include water, foam, one or more dry chemicals, one or more gases, and/or any other type of substance designed to cool, smother, or interrupt chemical reactions that sustain fire. As described herein, a fire extinguishing device 325 may include a reservoir (e.g., a flame retardant reservoir), which may be filled with one or more fire suppressants. The fire extinguishing device 325 may then deploy or otherwise expel the fire suppressant via one or more nozzles (e.g., based on a control signal that causes one or more valves to be opened).

In some examples, a stabilization operation may include one or more actions that may be performed to stabilize an object, such as an aerial vehicle 305, a fire extinguishing device 325, a tether, and/or the like. In some examples, performing a stabilization operation may include activating or otherwise controlling one or more propulsion systems 310-b of a fire extinguishing device 325 to stabilize the fire extinguishing device 325. In some examples, the one or more propulsion systems 310-b may be activated or otherwise controlled based on information indicative of one or more forces acting on the fire extinguishing device 325, such as the force generated by the expulsion of fire suppressant form the fire extinguishing device 325. In such examples, the information indicative of one or more forces acting on the fire extinguishing device 325 may include one or more fire suppressant parameters, which may indicate that fire suppressant is being expelled from the fire extinguishing device 325 or an intensity at which fire suppressant is expelled from the fire extinguishing device 325. In such examples, one or more propulsion parameters may be updated or configured based on one or more fire suppressant parameters.

In one embodiment, one or more processors (e.g., of the aerial vehicle 305, of the fire extinguishing device 325, or of any other device or system) may be configured to determine one or more propulsion parameters for the propulsion system 310-b based at least in part on one or more fire suppressant parameters. The one or more stabilization operations may use or be based on the one or more propulsion parameters. In some examples, a fire suppressant parameter may be a value, or an indicator of a configuration associated with expelling fire suppressant from a fire extinguishing device 325. For example, a binary fire suppressant parameter may indicate whether a fire suppressant valve is open or closed and/or whether or not fire suppressant is being expelled from a fire extinguishing device 325. In some examples, a fire suppressant parameter may indicate a velocity or intensity (e.g., qualitative or quantitative) at which a fire suppressant is expelled from a fire extinguishing device 325. As described herein, a fire suppressant parameter may be indicated using one or more values.

In some examples, a propulsion parameter may be a value, or an indicator of a configuration associated with one or more propulsion systems 310. For example, a binary propulsion parameter may indicate whether one or more propulsion systems 310 are activated or deactivated, or a degree of power provided to and/or by one or more propulsion systems 310. In some examples, a propulsion parameter may indicate a thrust or power (e.g., qualitative or quantitative) provided by one or more propulsion systems 310. As described herein, propulsion parameter may be indicated using one or more values.

In one embodiment, one or more processors (e.g., of the aerial vehicle 305, of the fire extinguishing device 325, or of any other device or system) may be configured to determine the threshold distance based at least in part on one or more downdraft values. In some examples, a downdraft value may be a value indicative of an amount of downdraft generated by one or more propulsion systems 310. A downdraft value may be a volume flow rate, a velocity, a distance, or any other type of measurement or characterization of an intensity and/or geometry of a downdraft. As one illustrative example, a downdraft value may indicate a distance from one or more propulsion systems 310 at which a downdraft is present. As described herein a threshold distance between a location 340 and a fire location 350 may be determined based on one or more downdraft values. In some examples, one or more processors may determine the threshold distance based on the one or more downdraft values.

In one embodiment, the fire extinguishing device 325 may comprise one or more sensors 330 configured to detect the fire location 350. In some examples, a sensor 330 may be a device or component that detects and/or outputs data (e.g., one or more values) in response to various stimuli. The data output by a sensor 330 may be utilized by one or more processors to make one or more determinations and/or to generate other data. For example, one or more processors may receive thermal imaging data output by one or more sensors 330 of a fire extinguishing device 325. The one or more processors may then determine a fire location 350 based on the thermal imaging data. As described herein, the term “sensor,” such as sensor 330, may refer to any type of sensor such as a vision-based sensor (e.g., a video camera, a thermal camera), an accelerometer, a GPS sensor, an altimeter, an ultrasonic sensor, a radar sensor, a temperature sensor, a humidity sensor, and/or the like.

In some examples, sensor data 355 may be data generated, detected, and/or output by one or more sensors 330. For example, a temperature sensor may detect and/or output sensor data 355, such as one or more temperature values. As described herein, sensor data 355 may be utilized to perform one or more operations and/or to make one or more determinations (e.g., by one or more processors). For example, one or more processors may receive sensor data 355, such as acceleration data, and determine a position and/or acceleration of a device and/or aerial vehicle 305 based on the sensor data 355.

In one embodiment, the tether assembly 315 may be configured to lower the fire extinguishing device 325 to a fire extinguishing device approach location 345. The fire extinguishing device approach location 345 may be based at least in part on the fire location 350. In some examples, a fire extinguishing device approach location 345 may be a third location associated with a fire. A fire extinguishing device approach location 345 may be a location that a fire extinguishing device 325 is lowered to in order to apply fire suppressant to a fire. For example, an aerial vehicle may travel to a location 340 and remain stationary at the location 340 for a period of time while the aerial vehicle lowers a fire extinguishing device 325 to a fire extinguishing device approach location 345. In some examples, a fire extinguishing device approach location 345 may be adjacent to a fire location 350. In some examples, a fire extinguishing device approach location 345 may be a threshold distance from a fire location 350 (e.g., so that the fire extinguishing device 325 is not burned or otherwise adversely affected by heat from the fire).

In one embodiment, one or more processors (e.g., of the aerial vehicle 305, of the fire extinguishing device 325, or of any other device or system) may be configured to determine the fire extinguishing device approach location 345 based at least in part on sensor data 355 from one or more sensors 330 of the fire extinguishing device 325. In some examples, sensor data 355 may be data generated, detected, and/or output by one or more sensors 330. For example, a temperature sensor may detect and/or output sensor data 355, such as one or more temperature values. As described herein, sensor data 355 may be utilized to perform one or more operations and/or to make one or more determinations (e.g., by one or more processors). For example, one or more processors may receive sensor data 355, such as acceleration data, and determine a position and/or acceleration of a device and/or aerial vehicle 305 based on the sensor data 355.

In one embodiment, one or more second vehicles (not shown) may be configured to determine the fire location 350 and communicate the fire location 350 to the aerial vehicle 305. In one embodiment, the aerial vehicle 305 may be configured to determine the fire location 350. In one embodiment, one or more processors (e.g., of the aerial vehicle 305, of the fire extinguishing device 325, or of any other device or system) may be configured to determine the fire location 350 based at least in part on lightning strike data and moisture-based fire risk data.

In some examples, lightning strike data may be data indicative of information associated with one or more lightning strikes. For example, lightning strike data may indicate one or more geographical locations of one or more lightning strikes. In some examples, lightning strike data may indicate one or more time instances at which one or more lightning strikes have occurred. For example, the one or more time instances may be linked to or may otherwise correspond to the one or more geographical locations. In some examples, lightning strike data may be utilized to determine a fire location 350 (e.g., in combination with moisture-based fire risk data). In some examples, lightning strike data may be utilized to determine one or more potential fire locations, which may be further investigated (e.g., by one or more aerial vehicles) to determine if a fire exists in such a location. In some examples, the one or more aerial vehicles may not include a fire extinguishing device 325 and may relay fire confirmation information to one or more aerial vehicles 305 including a fire extinguishing device 325. In such examples, the one or more aerial vehicles that confirm whether a fire exists at a potential fire location may be smaller and/or more efficient than one or more aerial vehicles 305 that include a fire extinguishing device 325, which may conserve resources.

In some examples, moisture-based fire risk data may be data indicative of fire risk based on historical moisture or precipitation values. In some examples, moisture-based fire risk data may correspond to one or more specific regions or geographic areas. Moisture-based fire risk data may include one or more fire risk values corresponding to one or more geographical areas. For example, a moisture-based fire risk value for a region that has experienced drought conditions over a time period may be higher than a moisture-based fire risk value for a region that has experienced a higher amount of precipitation over a time period.

In one embodiment, the fire extinguishing device 325 may include one or more wedge structures 335 configured to displace one or more obstacles. In some examples, a wedge structure 335 may be a structure or shape capable of displacing one or more obstacles. Through one or more applied forces, a wedge structure 335 may move through one or more obstacles in a path of travel for the wedge structure 335. In some examples, a wedge structure 335 may have a pyramidal or a conical shape. As described herein, a fire extinguishing device 325 may include or otherwise be formed in the shape of one or more wedge structures 335. For example, a fire extinguishing device 325 may be formed in the shape of a bicone or an octahedron. Such a geometry may enable the fire extinguishing device 325 to displace one or more obstacles, such as one or more tree branches as the fire extinguishing device 325 is positioned. Although some examples described herein refer to singular aerial vehicles 305, tether assemblies 315, retractable tethers 320, fire extinguishing devices 325, and locations, the described techniques may be applied to and/or performed using one or more aerial vehicles 305, one or more tether assemblies 315, one or more retractable tethers 320, one or more fire extinguishing devices 325, and one or more locations.

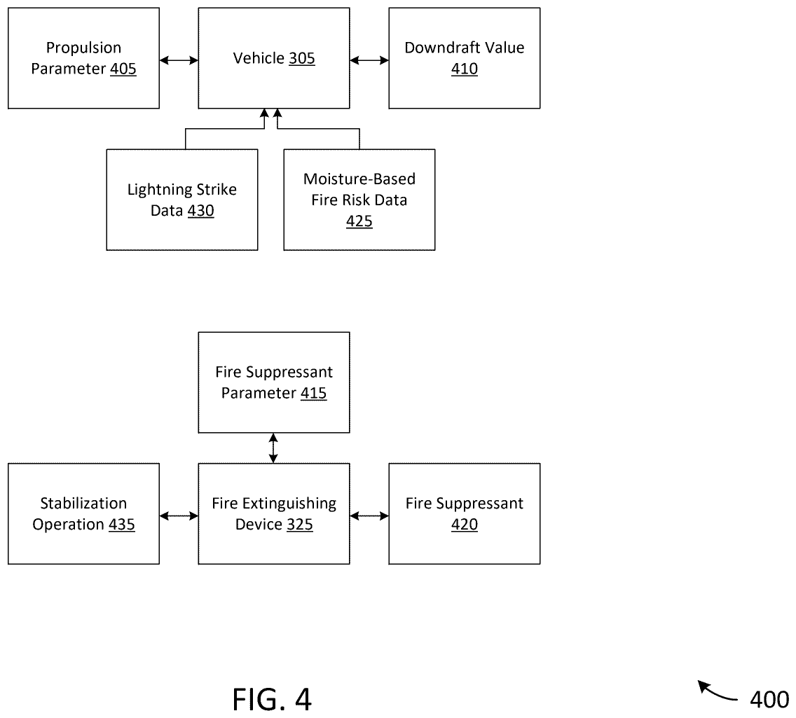

FIG. 4 illustrates a data flow diagram 400 in accordance with some embodiments discussed herein. The data flow diagram 400 may illustrate examples of one or more devices, components, and/or substances as described herein, such as an aerial vehicle 305, a fire extinguishing device 325, and/or a fire suppressant 420. Additionally, or alternatively, the data flow diagram 400 may illustrate one or more operations, which may be performed by any one or more of the devices and/or components. The data flow diagram 400 may provide one or more examples of data, values, parameters, and/or operations, such as a propulsion parameter 405, a downdraft value 410, a fire suppressant parameter 415, moisture-based fire risk data 425, lightning strike data 430, and/or a stabilization operation 435. The data, values, parameters, and/or operations may be generated, communicated, input, output, processed, performed, and/or the like by any one or more of the devices and/or components described herein.

In one embodiment, an aerial vehicle 305 and/or a control system of an aerial vehicle 305 may be controlled by or may receive one or more inputs from one or more individuals, such as a pilot or a driver. In some other examples, an aerial vehicle 305 may be autonomous or unmanned. For example, an autonomous vehicle may navigate and/or perform one or more other operations based on information received by one or more sensor systems and/or information determined by one or more processors of the aerial vehicle 305. Such information may be received, determined, generated, and/or processed without human intervention or with a threshold level of human intervention, such as human intervention to initialize and/or terminate one or more operations (e.g., a human may power on and/or launch an aerial vehicle 305 and subsequently allow the aerial vehicle 305 to operate autonomously).

As described herein, an aerial vehicle 305 may be an aircraft, a spacecraft, a satellite, an unmanned aerial vehicle (UAV), unmanned aircraft system (UAS), and/or the like. An aerial vehicle 305 may be equipped with one or more systems, such as one or more computing devices. In some examples, an aerial vehicle 305 may communicate with one or more other vehicles and/or devices via a wireless network. For example, a computing entity of an aerial vehicle 305 may include one or more communication interfaces, which may enable the aerial vehicle 305 to wirelessly communicate with one or more other vehicles and/or computing entities.

An aerial vehicle 305 may include one or more sensors 330, which may be utilized to generate data, such as image data (e.g., visible light image data, infrared image data, thermal image data, and/or the like). In some examples, the image data may be representative of an environment in which the aerial vehicle 305 is operating and/or one or more objects and/or phenomenon (e.g., a fire, weather phenomenon) within a range of the one or more sensors 330. In some examples, one or more aerial vehicle control systems may utilize image data generated by the one or more sensors 330 for control and/or navigation of the aerial vehicle 305. For example, one or more aerial vehicle control systems may be activated, deactivated, or otherwise adjusted based on the image data.

In some examples, an aerial vehicle 305 may include one or more navigational systems and/or sensors 330. For example, an aerial vehicle 305 may include one or more accelerometers, one or more global positioning system (GPS) devices, and/or the like. The one or more navigational systems and/or sensors 330 may output navigational information (e.g., location information, speed information, velocity information), which may be utilized by one or more processors to perform one or more operations, such as one or more control operations. In some examples, the one more navigational systems may be utilized to control an aerial vehicle 305 in the presence of one or more destabilizing forces, such as environmental forces (e.g., wind forces) and/or forces generated by the expulsion of fire suppressant.

In one embodiment, a fire extinguishing device 325 may be configured to expel a fire suppressant towards the fire and perform one or more stabilization operations using the propulsion system 310-b based at least in part on expelling the fire suppressant. In some examples, a fire extinguishing device 325 may be a device configured to release, discharge, and/or expel one or more fire suppressants. In some examples, a fire extinguishing device 325 may be coupled with a retractable tether 320 and/or a tether assembly 315. A fire extinguishing device 325 may include one or more winches, a housing, one or more fire suppressant reservoirs (e.g., one or more flame retardant reservoirs), one or more flow regulators, one or more nozzles, one or more propulsion systems 310-b (e.g., one or more ducted fans), one or more sensors 330 (e.g., one or more video and/or thermal cameras), one or more computing entities, and/or one or more power systems (e.g., one or more batteries). In some examples, a housing of the fire extinguishing device 325 may be formed in the shape of a wedge and/or have a conical geometry, which may enable the fire extinguishing device 325 to travel through one or more obstacles (e.g., tree branches) without getting stuck.

A fire extinguishing device 325 may include one or more sensors 330, which may be utilized to generate data, such as image data (e.g., visible light image data, infrared image data, thermal image data, and/or the like). In some examples, the image data may be representative of an environment in which the fire extinguishing device 325 is operating and/or one or more objects and/or phenomenon (e.g., a fire, weather phenomenon) within a range of the one or more sensors 330. In some examples, one or more control systems may utilize image data generated by the one or more sensors 330 for control and/or navigation of the fire extinguishing device 325. For example, one or more propulsion systems 310-b of the fire extinguishing device 325 and/or a winch controlling extension and retraction of a tether may be activated, deactivated, or otherwise adjusted based on the image data.

In some examples, a fire extinguishing device 325 may include one or more navigational systems and/or sensors 330. For example, a fire extinguishing device 325 may include one or more accelerometers, one or more GPS devices, and/or the like. The one or more navigational systems and/or sensors 330 may output navigational information (e.g., location information, speed information, velocity information), which may be utilized by one or more processors to perform one or more operations, such as one or more control operations. In some examples, the one more navigational systems may be utilized to control the fire extinguishing device 325 in the presence of one or more destabilizing forces, such as environmental forces (e.g., wind forces) and/or forces generated by the expulsion of fire suppressant. For example, one or more accelerometers may output one or more signals indicating displacement of the fire extinguishing device 325 (e.g., due to wind forces). In response to receiving the one or more signals, one or more processors may cause one or more propulsion systems 310-b of the fire extinguishing device 325 to be activated, thereby stabilizing the fire extinguishing device 325.

In some examples, a fire extinguishing device 325 may include one or more propulsion systems 310-b (e.g., one or more ducted fans), which may enable the fire extinguishing device 325 to move in one or more directions. For example, the one or more propulsion systems 310-b may control movement of the fire extinguishing device 325 in a horizontal direction, a vertical direction, a rotational direction, and/or the like. The one or more propulsion systems 310-b may be configured to cause the fire extinguishing device 325 to travel to one or more locations (e.g., one or more fire extinguishing device approach locations 345). The one or more locations may be determined by one or more processors of the fire extinguishing device 325 and/or one or more other processors (e.g., one or more cloud-based processors, one or more processors of one or more aerial vehicles 305, one or more processors of a ground-based control system).

In some examples, a fire suppressant may be a substance used to control, extinguish, suppress, and/or prevent fires. A fire suppressant may include water, foam, one or more dry chemicals, one or more gases, and/or any other type of substance designed to cool, smother, or interrupt chemical reactions that sustain fire. As described herein, a fire extinguishing device 325 may include a reservoir (e.g., a flame retardant reservoir), which may be filled with one or more fire suppressants. The fire extinguishing device 325 may then deploy or otherwise expel the fire suppressant via one or more nozzles (e.g., based on a control signal that causes one or more valves to be opened).

In some examples, a stabilization operation may include one or more actions that may be performed to stabilize an object, such as an aerial vehicle 305, a fire extinguishing device 325, a tether, and/or the like. In some examples, performing a stabilization operation may include activating or otherwise controlling one or more propulsion systems 310-b of a fire extinguishing device 325 to stabilize the fire extinguishing device 325. In some examples, the one or more propulsion systems 310-b may be activated or otherwise controlled based on information indicative of one or more forces acting on the fire extinguishing device 325, such as the force generated by the expulsion of fire suppressant form the fire extinguishing device 325. In such examples, the information indicative of one or more forces acting on the fire extinguishing device 325 may include one or more fire suppressant parameters, which may indicate that fire suppressant is being expelled from the fire extinguishing device 325 or an intensity at which fire suppressant is expelled from the fire extinguishing device 325. In such examples, one or more propulsion parameters may be updated or configured based on one or more fire suppressant parameters.

In one embodiment, one or more processors (e.g., of the aerial vehicle 305, of the fire extinguishing device 325, or of any other device or system) may be configured to determine one or more propulsion parameters for the propulsion system 310-b based at least in part on one or more fire suppressant parameters. The one or more stabilization operations may use the one or more propulsion parameters. In some examples, a fire suppressant parameter may be a value, or an indicator of a configuration associated with expelling fire suppressant from a fire extinguishing device 325. For example, a binary fire suppressant parameter may indicate whether a fire suppressant valve is open or closed and/or whether or not fire suppressant is being expelled from a fire extinguishing device 325. In some examples, a fire suppressant parameter may indicate a velocity or intensity (e.g., qualitative or quantitative) at which a fire suppressant is expelled from a fire extinguishing device 325. As described herein, a fire suppressant parameter may be indicated using one or more values.

In some examples, a propulsion parameter may be a value, or an indicator of a configuration associated with one or more propulsion systems 310. For example, a binary propulsion parameter may indicate whether one or more propulsion systems 310 are activated or deactivated, or a degree of power provided to and/or by one or more propulsion systems 310. In some examples, a propulsion parameter may indicate a thrust or power (e.g., qualitative or quantitative) provided by one or more propulsion systems 310. As described herein, propulsion parameter may be indicated using one or more values.

In one embodiment, one or more processors (e.g., of the aerial vehicle 305, of the fire extinguishing device 325, or of any other device or system) may be configured to determine the threshold distance based at least in part on one or more downdraft values. In some examples, a downdraft value may be a value indicative of an amount of downdraft generated by one or more propulsion systems 310. A downdraft value may be a volume flow rate, a velocity, a distance, or any other type of measurement or characterization of an intensity and/or geometry of a downdraft. As one illustrative example, a downdraft value may indicate a distance from one or more propulsion systems 310 at which a downdraft is present. As described herein a threshold distance between a location 340 and a fire location 350 may be determined based on one or more downdraft values. In some examples, one or more processors may determine the threshold distance based on the one or more downdraft values.

In one embodiment, one or more second vehicles may be configured to determine the fire location 350 and communicate the fire location 350 to the aerial vehicle 305. In one embodiment, the aerial vehicle 305 may be configured to determine the fire location 350. In one embodiment, one or more processors (e.g., of the aerial vehicle 305, of the fire extinguishing device 325, or of any other device or system) may be configured to determine the fire location 350 based at least in part on lightning strike data and moisture-based fire risk data.

In some examples, lightning strike data may be data indicative of information associated with one or more lightning strikes. For example, lightning strike data may indicate one or more geographical locations of one or more lightning strikes. In some examples, lightning strike data may indicate one or more time instances at which one or more lightning strikes have occurred. For example, the one or more time instances may be linked to or may otherwise correspond to the one or more geographical locations. In some examples, lightning strike data may be utilized to determine a fire location 350 (e.g., in combination with moisture-based fire risk data). In some examples, lightning strike data may be utilized to determine one or more potential fire locations, which may be further investigated (e.g., by one or more aerial vehicles) to determine if a fire exists in such a location. In some examples, the one or more aerial vehicles (e.g., one or more second vehicles) may not include a fire extinguishing device 325 and may relay fire confirmation information to one or more aerial vehicles 305 including a fire extinguishing device 325. In such examples, the one or more aerial vehicles that confirm whether a fire exists at a potential fire location may be smaller and/or more efficient than one or more aerial vehicles 305 that include a fire extinguishing device 325, which may conserve resources.

In some examples, moisture-based fire risk data may be data indicative of fire risk based on historical moisture or precipitation values. In some examples, moisture-based fire risk data may correspond to one or more specific regions or geographic areas. Moisture-based fire risk data may include one or more fire risk values corresponding to one or more geographical areas. For example, a moisture-based fire risk value for a region that has experienced drought conditions over a time period may be higher than a moisture-based fire risk value for a region that has experienced a higher amount of precipitation over a time period.

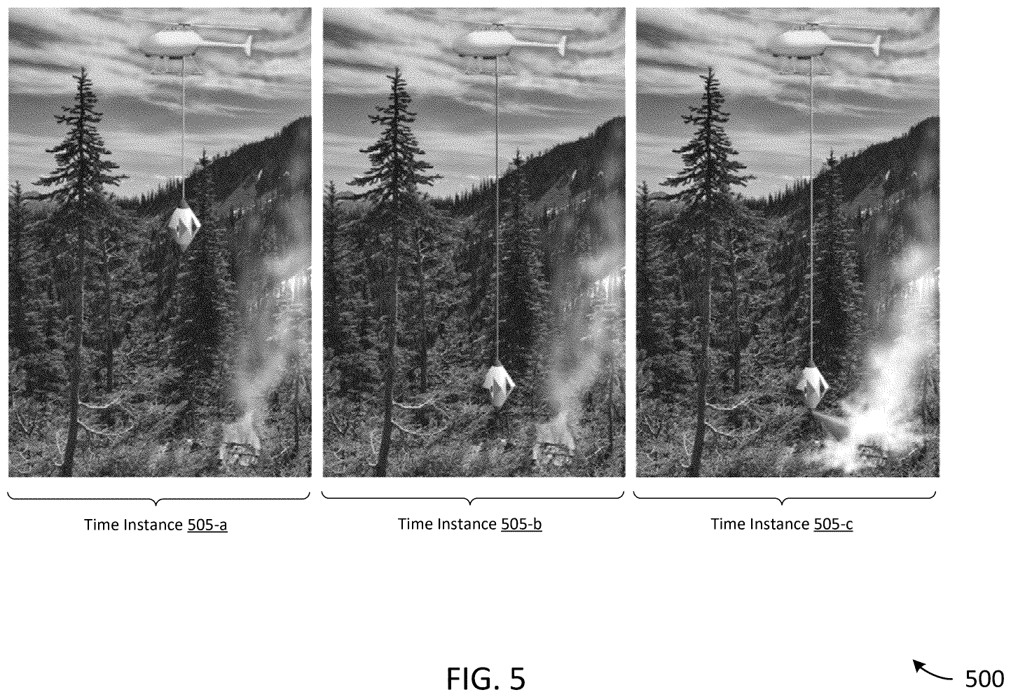

FIG. 5 illustrates an operational example 500 of a firefighting system in accordance with some embodiments discussed herein. The firefighting system may include an aerial vehicle (e.g., a crewed or uncrewed aircraft), a tether assembly, and a fire extinguishing device. The aerial vehicle may be configured to lower the fire extinguishing device using the tether assembly. In some examples, the aerial vehicle may lower the fire extinguishing device to a fire extinguishing device approach location. The fire extinguishing device approach location may be a location from which the fire extinguishing device may expel fire suppressant towards a fire.

The operational example 500 may illustrate the firefighting system at a series of time instances 505. The time instance 505-a may occur prior to the time instance 505-b and the time instance 505-b may occur prior to the time instance 505-c. At the time instance 505-a, the aerial vehicle may be positioned at a location. Additionally, or alternatively, a fire extinguishing device lowering operation may be in progress. For example, the fire extinguishing device may be at a midpoint of a lowering path (e.g., the fire extinguishing device has not yet reached the fire extinguishing device approach location). At the time instance 505-b, the fire extinguishing device may be positioned at the fire extinguishing device approach location. At the time instance 505-c, the fire extinguishing device may be expelling a fire suppressant towards the fire. Additionally, or alternatively, the fire extinguishing device may be performing one or more stabilization operations.

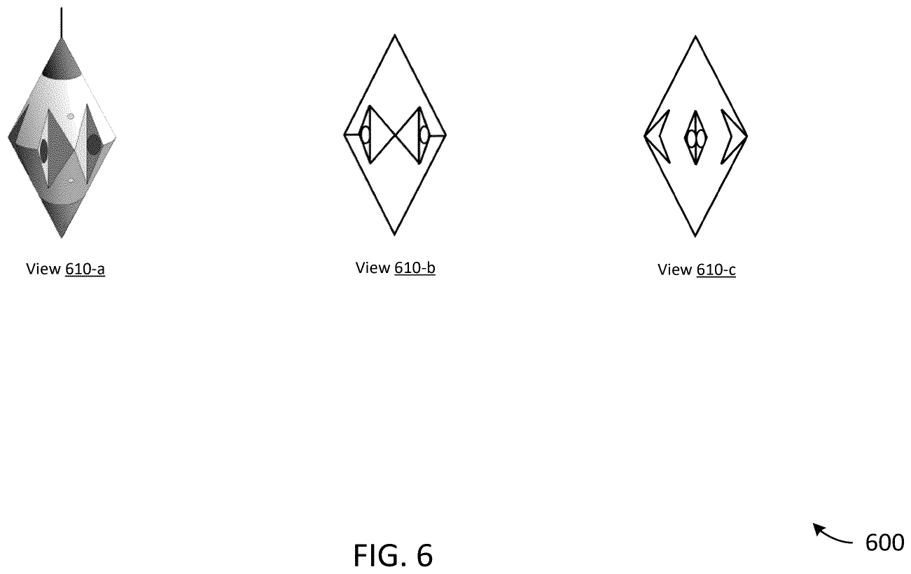

FIG. 6 illustrates an operational example 600 of a fire extinguishing device in accordance with some embodiments discussed herein. The operational example 600 may illustrate multiple views 610 of a fire extinguishing device, such as an isometric view (e.g., view 610-a), a first side view (e.g., view 610-b), and a second side view (e.g., view 610-c). As shown, the fire extinguishing device may be formed in the shape of or otherwise include one or more wedges, which may enable the fire extinguishing device to displace and/or move through one or more obstacles, such as a tree canopy.

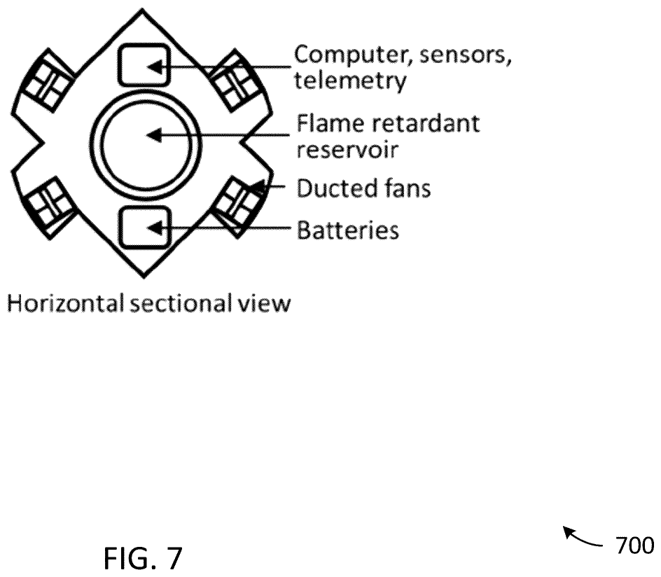

FIG. 7 illustrates an operational example 700 of a fire extinguishing device in accordance with some embodiments discussed herein. More specifically, the operational example 700 may illustrate a horizontal sectional view of the fire extinguishing device. As shown, the fire extinguishing device may include one or more computing entities (e.g., one or more computers), one or more sensors, one or more communication components (e.g., one or more telemetry components), one or more fire suppressant reservoirs (e.g., one or more flame retardant reservoirs), one or more propulsion systems (e.g., one or more ducted fans), and one or more batteries.

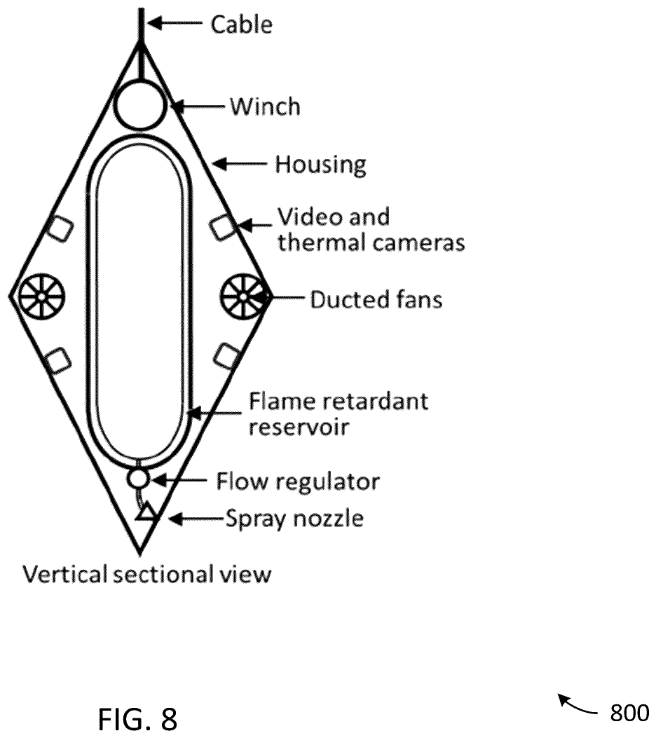

FIG. 8 illustrates an operational example 800 of a fire extinguishing device in accordance with some embodiments discussed herein. More specifically, the operational example 800 may illustrate a vertical section view of the fire extinguishing device. As shown, the fire extinguishing device may include a winch and a cable (e.g., a tether assembly). Additionally, or alternatively, the fire extinguishing device may include a housing (e.g., a wedge shaped housing), one or more sensors (e.g., one or more video cameras, one or more thermal cameras), one or more propulsion systems (e.g., one or more ducted fans), a fire suppressant reservoir (e.g., a flame retardant reservoir), one or more flow regulators, and one or more spray nozzles.

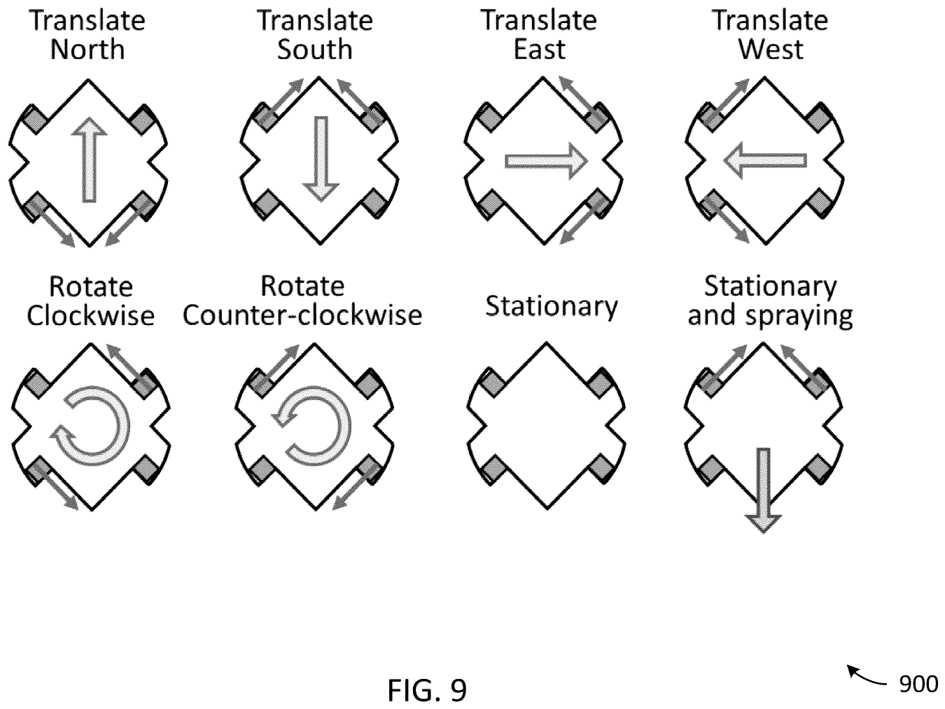

FIG. 9 illustrates an operational example 900 of positioning configurations for a fire extinguishing device in accordance with some embodiments discussed herein. For example, in a first positioning configuration, the fire extinguishing device may translate in a first direction (e.g., north). To translate in the first direction, the fire extinguishing device may activate a first set of ducted fans that generate thrust in a second direction opposite to the first direction. In a second positioning configuration, the fire extinguishing device may translate in the second direction (e.g., south). To translate in the second direction, the fire extinguishing device may activate a second set of ducted fans that generate thrust in the first direction opposite to the second direction.

In a third positioning configuration, the fire extinguishing device may translate in a third direction (e.g., east). To translate in the third direction, the fire extinguishing device may activate a third set of ducted fans that generate thrust in a fourth direction opposite to the third direction. In a fourth positioning configuration, the fire extinguishing device may translate in the third direction (e.g., west). To translate in the third direction, the fire extinguishing device may activate a fourth set of ducted fans that generate thrust in the fourth direction opposite to the third direction.

In a fifth positioning configuration, the fire extinguishing device may rotate in a clockwise direction. To rotate in the clockwise direction, the fire extinguishing device may activate a fifth set of ducted fans that generate thrust in a counterclockwise direction. In a sixth positioning configuration, the fire extinguishing device may rotate in a counterclockwise direction. To rotate in the counterclockwise direction, the fire extinguishing device may activate a sixth set of ducted fans that generate thrust in the clockwise direction.

In some examples, the fire extinguishing device may remain stationary. To remain stationary, the fire extinguishing device may deactivate each of the ducted fans. In some examples, to remain stationary, the fire extinguishing device may perform one or more stabilization operations. For example, the fire extinguishing device may activate one or more ducted fans to counteract one or more forces, such as one or more forces generated by the expulsion of fire suppressant and/or one or more wind forces.

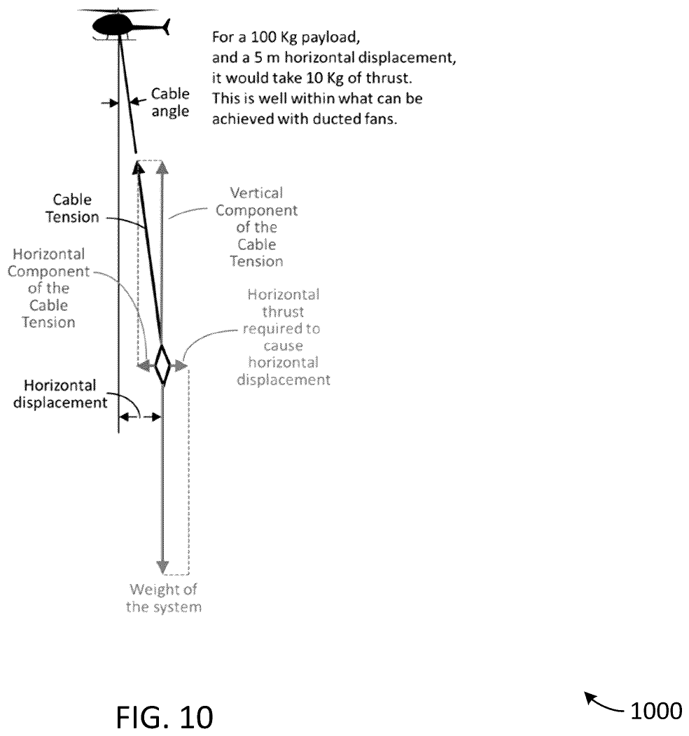

FIG. 10 illustrates an operational example 1000 of a firefighting system in accordance with some embodiments discussed herein. The firefighting system may include an aerial vehicle (e.g., a crewed or uncrewed aircraft), a tether assembly, and a fire extinguishing device. The aerial vehicle may be configured to lower the fire extinguishing device using the tether assembly. In some examples, the aerial vehicle may lower the fire extinguishing device to a fire extinguishing device approach location. The fire extinguishing device approach location may be a location from which the fire extinguishing device may expel fire suppressant towards a fire.

As shown, the operational example 1000 may illustrate a positioning configuration of the firefighting system. For example, the fire extinguishing device may activate one or more propulsion systems (e.g., of the fire extinguishing device) to translate in a first direction. In some examples, translating in the first direction may place the tether at an angle with respect to a vertical direction. In some examples, the fire extinguishing device may translate in the first direction to reach a fire extinguishing device approach location. Additionally, or alternatively, translating in the first direction may enable the fire extinguishing device to maneuver or otherwise position itself below one or more obstacles, such as a tree canopy. For example, it may be advantageous for the fire extinguishing device to be lowered at a location adjacent to a tree canopy and then translate horizontally, underneath the tree canopy, to a fire extinguishing device approach location

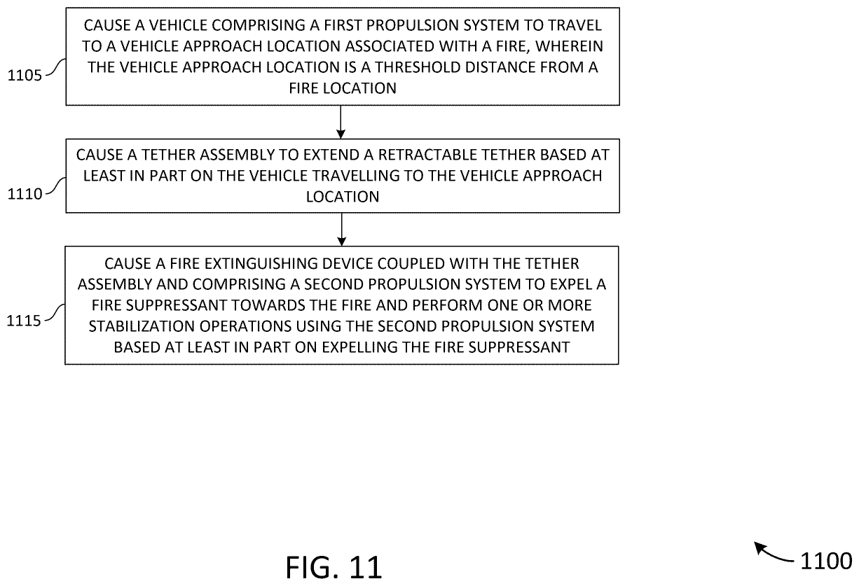

FIG. 11 provides an example flowchart 1100 in accordance with some embodiments described herein. The flowchart 1100 may include one or more examples of operations performed by a system or one or more subcomponents of a system, as described with reference to FIGS. 1-10. In accordance with examples described herein, any of the described operations may be performed multiple times or independently of other operations described herein.

As shown in block 1105, the system may include means, such as an aerial vehicle, a tether assembly, a fire extinguishing device, one or more processors, and/or the like, for causing an aerial vehicle comprising a first propulsion system to travel to a location associated with a fire, wherein the location is a threshold distance from a fire location.

As shown in block 1110, the system may include means, such as an aerial vehicle, a tether assembly, a fire extinguishing device, one or more processors, and/or the like, for causing a tether assembly to extend a retractable tether based at least in part on the aerial vehicle travelling to the location.

As shown in block 1115, the system may include means, such as an aerial vehicle, a tether assembly, a fire extinguishing device, one or more processors, and/or the like, for causing a fire extinguishing device coupled to the tether assembly and comprising a second propulsion system to (i) expel a fire suppressant towards the fire and (ii) perform one or more stabilization operations using the second propulsion system based at least in part on expelling the fire suppressant.

The flowchart 1100 depicts methods according to an example embodiment. It will be understood that each block and combination of blocks may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by memory of a computing entity as described herein. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

### VI. Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. An aerial vehicle comprising:
a first propulsion system, the aerial vehicle configured to travel to a location associated with a fire, wherein the location is a threshold distance from a fire location;
a tether assembly configured to extend a retractable tether based at least in part on the aerial vehicle travelling to the location; and
a fire extinguishing device coupled to the tether assembly and comprising a second propulsion system, the fire extinguishing device configured to (i) expel a fire suppressant towards the fire and (ii) perform one or more stabilization operations using the second propulsion system based at least in part on expelling the fire suppressant.

2. The aerial vehicle of claim 1, further comprising:
one or more processors configured to determine one or more propulsion parameters for the second propulsion system based at least in part on one or more fire suppressant parameters, wherein the one or more stabilization operations are based at least in part on the one or more propulsion parameters.

3. The aerial vehicle of claim 1, further comprising:
one or more processors configured to determine the threshold distance based at least in part on one or more downdraft values.

4. The aerial vehicle of claim 1, wherein the fire extinguishing device comprises one or more sensors configured to detect the fire location.

5. The aerial vehicle of claim 1, wherein the tether assembly is configured to lower the fire extinguishing device to a fire extinguishing device approach location, the fire extinguishing device approach location based at least in part on the fire location.

6. The aerial vehicle of claim 5, further comprising:
one or more processors configured to determine the fire extinguishing device approach location based at least in part on sensor data from one or more sensors of the fire extinguishing device.

7. The aerial vehicle of claim 1, further comprising:
one or more second vehicles configured to determine the fire location and communicate the fire location to the aerial vehicle.

8. The aerial vehicle of claim 1, wherein the aerial vehicle is configured to determine the fire location.

9. The aerial vehicle of claim 1, further comprising:
one or more processors configured to determine the fire location based at least in part on lightning strike data and moisture-based fire risk data.

10. The aerial vehicle of claim 1, wherein the fire extinguishing device comprises one or more wedge structures configured to displace one or more obstacles.

11. A method comprising:
causing, by one or more processors, an aerial vehicle to a location associated with a fire, wherein (A) the location is a threshold distance from a fire location and (b) the aerial vehicle comprises a first propulsion system to travel;
causing, by the one or more processors, a tether assembly to extend a retractable tether based at least in part on the aerial vehicle travelling to the location; and
causing, by the one or more processors, a fire extinguishing device coupled to the tether assembly and comprising a second propulsion system to (i) expel a fire suppressant towards the fire and (ii) perform one or more stabilization operations using the second propulsion system based at least in part on expelling the fire suppressant.

12. The method of claim 11, further comprising:
determining, by the one or more processors, one or more propulsion parameters for the second propulsion system based at least in part on one or more fire suppressant parameters, wherein the one or more stabilization operations use the one or more propulsion parameters.

13. The method of claim 11, further comprising:
determining, by the one or more processors, the threshold distance based at least in part on one or more downdraft values.

14. The method of claim 11, wherein the fire extinguishing device comprises one or more sensors configured to detect the fire location.

15. The method of claim 11, wherein causing the tether assembly to extend the retractable tether further comprises:
causing, by the one or more processors, the tether assembly to lower the fire extinguishing device to a fire extinguishing device approach location, the fire extinguishing device approach location based at least in part on the fire location.

16. The method of claim 15, further comprising:
determining, by the one or more processors, the fire extinguishing device approach location based at least in part on sensor data from one or more sensors of the fire extinguishing device.

17. The method of claim 11, further comprising:
receiving, by the one or more processors and from one or more second vehicles, an indication of the fire location.

18. The method of claim 11, further comprising:
determining, by the one or more processors, the fire location, wherein the aerial vehicle comprises the one or more processors.

19. The method of claim 11, further comprising:
determining, by the one or more processors, the fire location based at least in part on lightning strike data and moisture-based fire risk data.
